(19) United States
(12) Patent Application Publication
(10) Pub. No.: US 2014/0129508 A1
(43) Pub. Date: May 8, 2014

(54) Prediction Apparatus and Prediction Method

(71) Applicant: THE BANK OF TOKYO-MITSUBISHI UFJ, LTD., Tokyo (JP)

(72) Inventor: Hideo Kawamoto, Tokyo (JP)

(73) Assignee: THE BANK OF TOKYO-MITSUBISHI UFJ, LTD., Tokyo (JP)

(21) Appl. No.: 14/151,971

(22) Filed: Jan. 10, 2014

Related U.S. Application Data
(62) Division of application No. 13/074,315, filed on Mar. 29, 2011.

(30) Foreign Application Priority Data
Mar. 29, 2010 (JP) 2010-075199
May 19, 2010 (JP) 2010-115728
Jun. 28, 2010 (JP) 2010-146448
Sep. 6, 2010 (JP) 2010-198929

(51) Int. Cl. G06N 7/00

(52) U.S. Cl. CPC G06N 7/005
USPC 706/52; 706/46

(57) ABSTRACT

A prediction apparatus predicts an upper limit of the number of job executions per unit period in a system which executes a job responding to a request from outside. The prediction apparatus firstly acquires a sample data regarding the job. The sample data to be acquired is a sample data from which the number of job executions for each unit period in the past can be identified. Then, based on a distribution of the number of job executions identified from the sample data, the upper limit of the number of job executions per unit period in the future is predicted. Thereafter, the predicted upper limit is outputted.

### CROSS-REFERENCE TO RELATED APPLICATIONS

This application is a divisional U.S. application Ser. No. 13/074,315, filed Mar. 29, 2011, which claims the benefit of Japanese Patent Application No. 2010-198929 filed Sep. 6, 2010 in the Japan Patent Office, Japanese Patent Application No. 2010-146448 filed Jun. 28, 2010 in the Japan Patent Office, Japanese Patent Application No. 2010-115728 filed May 19, 2010 in the Japan Patent Office, and Japanese Patent Application No. 2010-075199 filed Mar. 29, 2010 in the Japan Patent Office, the disclosure of which is incorporated herein by reference.

### BACKGROUND

The present invention relates to an apparatus and a method for predicting an upper limit of the number of job executions per unit period in the future, and a recording medium that records a program which causes a computer to realize this prediction function.

Conventionally, a system which executes jobs responding to requests from outside is well-known. A subject who executes the jobs includes a person or a machine (in particular, a computer). As this kind of system, for example, a call center system is well-known. In the call center system, a request from a client is received through a telephone line, and a call-center agent executes a job responding to the request from the client. In addition, as this kind of system, a communication system is well-known. In the communication system, a request from a client's terminal device is received through communication lines, and a server device executes a job responding to the request.

Also, as the above communication system, a system which performs financial transactions using communication lines is well-known. For example, in an Internet banking system, a server device receives a remittance request from a client's terminal device through a network. Then, processing of transferring money from an account of the client requesting this remittance to an account to be transferred is executed. In addition, in a foreign exchange transaction system, a server device receives a transaction request from a client's terminal device through a network, and then executes a foreign exchange transaction involving currency exchange corresponding to the transaction request.

By the way, in the above-mentioned system which executes jobs responding to requests from outside, it is preferable that, even in the environment in which the number of requests changes with time, the job corresponding to each request can be smoothly executed. Especially, with respect to the transaction system dealing with financial transactions, in which market prices fluctuate from hour to hour, the stable capability of smoothly executing transactions is required.

As a conventional art, a technology of predicting the change of a resource amount used in each module provided in an information processing system is well-known. According to this technology, assignment of computer resources to each module in accordance with a result of the prediction is adjusted autonomously. Computer resources are thereby adequately assigned to modules.

In addition, as another conventional art, a technology of analyzing the transition of computer resource usage based on an actual operation of an information processing system is well-known. According to this technology, a trend of the future is predicted based on the analysis result. Then, this predicted result is used to improve operation of the system.

Also, as a technology related to financial transactions, a technology of predicting the future asset values using a computer is known.

### SUMMARY

The inventor intends to estimate a throughput necessary for a system, for the purpose of stable operation of the system, while inhibiting an excess investment in the above-described system (a server device which constitutes the above communication system, a call center system or the like).

That is, the inventor intends to predict an upper limit of the number of job executions per unit period, and estimate the throughput necessary for the system based on the predicted result. However, a technology of adequately predicting, for the above-described purpose, an upper limit of the number of job executions per unit period which may occur in the future is not fully established.

Therefore, in one aspect of the present invention, it is desirable to be capable of adequately predicting an upper limit of the number of job executions per unit period in the system which executes jobs responding to requests from outside.

A prediction apparatus in the first aspect of the present invention is an apparatus for predicting an upper limit of the number of job executions per unit period in the system which executes a job responding to a request from outside. The prediction apparatus includes an acquisition device and a prediction device.

The acquisition device acquires, as a sample data regarding the job, a sample data from which the number of job executions for each unit period in the past can be identified.

The prediction device predicts an upper limit of the number of job executions per unit period in the future, based on a distribution of the number of job executions for each unit period identified from the sample data acquired by the acquisition device. Then, the predicted upper limit is outputted.

According to the prediction apparatus, as described above, an upper limit of the number of job executions per unit period is predicted, based on the distribution of the number of job executions identified from the sample data. Therefore, an upper limit of the number of job executions per unit period to be realistically considered can be adequately predicted in consideration of future possibilities. As a result, the throughput of a system can be set to a necessary and sufficient extent, while inhibiting an excess investment in a system (an information processing system, etc.) which executes a job responding to a request from outside. Therefore, according to this prediction apparatus, a system can be efficiently managed.

Specifically, the prediction device can be configured to predict an upper limit of the number of job executions per unit period on an assumption that a probability distribution of the number of job executions per unit period follows a normal distribution.

For example, the prediction device can be configured to calculate a value of an endpoint of a confidence interval at a predetermined confidence level of the number of job executions for each unit period, based on the number of job executions for each unit period identified from the sample data. Furthermore, the prediction device can be configured to predict an upper limit of the number of job executions per unit period based on the calculated value of interval endpoint. In other words, the larger endpoint (an upper endpoint) of both endpoints of a confidence interval is predicted to be an upper limit of the number of job executions per unit period.

When the probability distribution of the number of job executions per unit period generally follows a normal distribution, an upper limit of the number of job executions per unit period can be predicted using a concept of confidence intervals as described above. Therefore, by using such a method, an upper limit of the number of job executions per unit period can be adequately predicted with a simple calculation.

Also, the prediction device may be configured to calculate a probability distribution of the number of job executions per unit period based on the number of job executions for each unit period identified from the sample data, and predict an upper limit of the number of job executions per unit period based on the calculated probability distribution.

Specifically, the prediction device can be configured to predict an upper limit of the number of job executions per unit period based on a cumulative probability of the number of job executions per unit period. The cumulative probability changes in accordance with the number of job executions per unit period, which functions as a variable. The cumulative probability is calculated by accumulating an occurrence probability for each value of the number of job executions per unit period identified from the probability distribution, in ascending order of the number of job executions per unit period, up to the value of the number of job executions per unit period corresponding to the variable.

In this case, a minimum value of the number of job executions per unit period in a range where the cumulative probability is greater than a specific probability can be predicted to be an upper limit of the number of job executions per unit period.

By predicting an upper limit of the number of job executions per unit period as described above, even when a probability distribution of the number of job executions per unit period does not follow a normal distribution, an upper limit can be adequately predicted.

Also, the prediction device can be configured to calculate the probability distribution with an action of correction to show unimodality, and predict the upper limit of the number of job executions per unit period based on the calculated probability distribution (unimodal probability distribution). The probability distribution which shows unimodality can be obtained by correcting occurrence probability in each point based on a point having the highest occurrence probability. When the probability distribution shows multimodality, the probability distribution is likely to be influenced by sampling error. Therefore, by making a correction as above, prediction accuracy can be inhibited from deteriorating due to the quality of a sample data.

Also, the above-described invention can be applied to a system which executes a transaction responding to a request from outside as the job. In this case, the prediction device can be configured to predict, as the upper limit of the number of job executions per unit period in the system, an upper limit of the number of transactions per unit period. An example of the transaction includes a financial transaction. The financial transaction requires reliability of a system. For this reason, by predicting an upper limit of the number of transactions per unit period using the prediction apparatus according to the present invention, a transaction system with high reliability can be configured at low cost.

In addition, a function as the prediction apparatus in the first aspect can be realized by a computer which executes a program. This program can be recorded in a computer readable recording medium and provided to a user. That is, a program, which causes a computer to execute the processing of predicting an upper limit of the number of job executions per unit period in a system executing a job responding to a request from outside, can be recorded in the recording medium. The processing includes procedures corresponding to the acquisition device and the prediction device.

Also, the idea corresponding to the prediction apparatus in the first aspect can be applied to an invention of a prediction method. That is, a prediction method of predicting an upper limit of the number of job executions per unit period in the system executing a job responding to a request from outside can be configured to include an acquisition procedure and a prediction procedure. The acquisition procedure is a procedure of acquiring a sample data regarding jobs, from which the number of job executions for each unit period in the past can be identified. Also, the prediction procedure is a procedure of predicting an upper limit of the number of job executions per unit period in the future, based on a distribution of the number of job executions for each unit period identified from the sample data acquired by the acquisition procedure. Furthermore, the prediction procedure outputs the predicted upper limit.

By the way, in a system dealing with transactions involving market prices, the number of transactions (the number of job executions) changes under the influence of market price fluctuations. Therefore, when an upper limit of the number of transactions per unit period with respect to the transactions involving market prices is predicted, it is preferable to consider fluctuation of the number of transactions caused by market price fluctuations.

A prediction apparatus in the second aspect of the present invention is a prediction apparatus for predicting an upper limit of the number of transactions per unit period for a specific type of transaction involving market prices. The prediction apparatus includes an acquisition device, a basic fluctuation amount calculation device, a basic transactions calculation device, and a prediction device, each of which will be explained below.

The acquisition device acquires a sample data regarding the specific type of transaction, from which the number of transactions for each unit period in the past and a market price fluctuation amount for each unit period in the past are obtained. On the other hand, the basic fluctuation amount calculation device calculates a basic fluctuation amount, based on the number of transactions and the market price fluctuation amount for each unit period, both identified from the sample data. The basic fluctuation amount is a fluctuation amount of the number of transactions per unit period relative to the market price fluctuation amount. For example, the “fluctuation amount of the number of transactions per unit period relative to the market price fluctuation amount” is defined by the fluctuation amount of the number of transactions per unit period when the market price fluctuation amount per unit period changes by unit amount.

Also, the basic transactions calculation device calculates the basic number of transactions for each unit period, based on the basic fluctuation amount, and the number of transactions and the market price fluctuation amount for each unit period. The basic number of transactions for each unit period is the number of transactions for each unit period on an assumption that market price fluctuations do not exist.

For example, the basic transactions calculation device estimates, for each unit period, a fluctuation amount of the number of transactions caused by market price fluctuations in the period, based on the basic fluctuation amount and the market price fluctuation amount in the period. Then when the estimated fluctuation amount is positive, the basic number of transactions is calculated by subtracting an absolute value of the estimated fluctuation amount from the actual number of transactions in the period identified from the sample data. On the other hand, when the estimated fluctuation amount is negative, the basic number of transactions is calculated by adding the absolute value of the estimated fluctuation amount to the actual number of transactions.

Specifically, the basic transactions calculation device can be configured to estimate, for each unit period, a value obtained by multiplying the market price fluctuation amount in the period identified from the sample data by the basic fluctuation amount, to be a fluctuation amount of the number of transactions caused by market price fluctuations in the period.

Then, the prediction device predicts an upper limit of the number of transactions per unit period for the specific type of transaction, based on a distribution of the basic number of transactions identified from the basic number of transactions for each unit period, a distribution of the market price fluctuation amount identified from the market price fluctuation amount for each unit period, and the basic fluctuation amount. Furthermore, the prediction device outputs the predicted upper limit.

For example, the prediction device can be configured to predict an upper limit of the basic number of transactions based on the distribution of the basic number of transactions, and predict an upper limit of the fluctuation amount of the number of transactions caused by market price fluctuations based on the distribution of the market price fluctuation amount and the basic fluctuation amount. That is, the prediction device can be configured to predict an upper limit of the number of transactions per unit period, based on the predicted result of these upper limits.

According to this prediction apparatus, an upper limit of the number of transactions per unit period is predicted by analyzing a sample data in detail. Therefore, the upper limit can be predicted with high accuracy.

As a result, by using this prediction apparatus, it is possible to precisely estimate a computer resource (hereinafter referred to as a “resource”), which is necessary for a system dealing with a transaction involving market price fluctuations. Therefore, it is not necessary to make an excess investment for a stable operation of the system.

Examples of the specific type of transaction described above include a foreign exchange transaction and a financial transaction in the market of stocks, bonds, gold or the like. Also, the prediction apparatus can be configured to predict an upper limit of the number of transactions per unit period by evaluating the market price fluctuation amount with an absolute value. Furthermore, the prediction apparatus may be configured to predict an upper limit of the number of transactions per unit period by evaluating the market price fluctuation amount with a signed fluctuation amount.

Also, the acquisition device may simply acquire, as a sample data, a sample data from which the number of transactions for each unit period and the market price fluctuation amount for each unit period with respect to at least one of the market price appreciation period and the market price depreciation period can be identified.

The market price appreciation period as used herein refers to a period in which the market price fluctuation amount is positive. Also, the market price depreciation period refers to a period in which the market price fluctuation amount is negative. In the case of a foreign exchange transaction, the “market price depreciation” and the “market price appreciation” are normally defined based on the first currency (for example, a dollar in the case of dollar/yen). However, the definition of the “market price depreciation” and the “market price appreciation” is not limited to the above. In other words, the “market price depreciation” and the “market price appreciation” may be defined based on an intended asset.

That is, the prediction apparatus can be configured to predict an upper limit of the number of transactions per unit period, based on, for example, only samples (the number of transactions for each unit period and the market price fluctuation amount for each unit period) during market price appreciation. In addition, the prediction apparatus may be configured to predict an upper limit of the number of transactions per unit period based on only samples during market price depreciation.

In addition, the prediction apparatus can be configured, of course, to predict an upper limit of the number of transactions per unit period, based on the samples in both the market price appreciation period and the market price depreciation period.

However, it is predicted that the fluctuation amount of the number of transactions caused by the market price fluctuation is not uniform between the market price appreciation period and the market price depreciation period. Therefore, the basic fluctuation amount calculation device is desirably configured to calculate, as a basic fluctuation amount, the first basic fluctuation amount which is the basic fluctuation amount during market price appreciation, and the second basic fluctuation amount which is the basic fluctuation amount during market price depreciation.

Specifically, the first basic fluctuation amount can be calculated based on the number of transactions and the market price fluctuation amount for each unit period in the first period, in which the market price fluctuation amount is positive. Also, the second basic fluctuation amount can be calculated based on the number of transactions and the market price fluctuation amount for each unit period in the second period, in which the market price fluctuation amount is negative.

When the basic fluctuation amount calculation device is configured as described above, the basic transactions calculation device can be configured to calculate the basic number of transactions for each unit period in the first period using the first basic fluctuation amount, and to calculate the basic number of transactions for each unit period in the second period using the second basic fluctuation amount.

Specifically, for a unit period which belongs to the first period, the basic transactions calculation device can be configured to estimate a value obtained by multiplying the market price fluctuation amount in the period identified from the sample data by the first basic fluctuation amount, to be a fluctuation amount of the number of transactions caused by market price fluctuations in the period.

Similarly, for a unit period which belongs to the second period, the basic transactions calculation device can be configured to estimate a value obtained by multiplying the market price fluctuation amount in the period identified from the sample data by the second basic fluctuation amount, to be a fluctuation amount of the number of transactions caused by market price fluctuations in the period.

By calculating the first and second basic fluctuation amounts as described above, the fluctuation amount of the number of transactions caused by market price fluctuations in each period of market price appreciation and market price depreciation can be adequately estimated. Accordingly, the basic number of transactions can be calculated with high accuracy. As a result, the upper limit of the number of transactions per unit period can be also predicted with high accuracy.

Also, the prediction device can be configured to predict an upper limit of the number of transactions per unit period for the specific type of transaction, based on the basic number of transactions and the market price fluctuation amount for each unit period, and the first and second basic fluctuation amounts.

For example, the prediction device predicts an upper limit of the basic number of transactions based on a distribution of the basic number of transactions identified from the basic number of transactions for each unit period. On the other hand, a variation range of the market price fluctuation amount in the future is predicted based on a distribution of the market price fluctuation amount identified from the market price fluctuation amount for each unit period. Then, an upper limit of the fluctuation amount of the number of transactions caused by market price fluctuations is predicted based on the variation range of the market price fluctuation amount and the first and second basic fluctuation amounts. Then, based on these predicted values, an upper limit of the number of transactions per unit period is predicted.

Also, the prediction device can be configured to predict an upper limit of the number of transactions per unit period described above, using a concept of a confidence interval.

For example, the prediction device can be configured to include a first confidence interval endpoint calculation device and a second confidence interval endpoint calculation device, each of which is described below.

The first confidence interval endpoint calculation device is a device that calculates a value of an endpoint of a confidence interval at a predetermined confidence level of the basic number of transactions, based on the basic number of transactions for each unit period. On the other hand, the second confidence interval endpoint calculation device is a device that calculates a value of an endpoint of a confidence interval at a predetermined confidence level of the market price fluctuation amount based on the market price fluctuation amount for each unit period.

That is, the prediction device can be configured to predict an upper limit of the number of transactions per unit period for the specific type of transaction, based on the calculated value by the first confidence interval endpoint calculation device, the calculated value by the second confidence interval endpoint calculation device, and the basic fluctuation amount.

Specifically, the prediction device can be configured to predict an upper limit of the fluctuation amount of the number of transactions per unit period associated with market price fluctuations, based on the calculated value by the second confidence interval endpoint calculation device and the basic fluctuation amount, and to predict an upper limit of the number of transactions per unit period when market price fluctuations do not exist, based on the calculated value by the first confidence interval endpoint calculation device (in particular, a value of an upper endpoint which value is larger). Then, the prediction device can be configured to predict a value obtained by adding the predicted upper limit of the fluctuation amount of the number of transactions per unit period associated with market price fluctuations to the predicted upper limit of the number of transactions per unit period when market price fluctuations do not exist, as an upper limit of the number of transactions per unit period for the specific type of transaction.

On the other hand, when the first and second basic fluctuation amounts are calculated, the prediction device can be configured to perform the following processing, based on the calculated value by the first confidence interval endpoint calculation device, the calculated value by the second confidence interval endpoint calculation device, and the first and second basic fluctuation amounts.

That is, the prediction device can be configured to predict, as an upper limit of the number of transactions per unit period for the specific type of transaction, an upper limit of the number of transactions per unit period during market price appreciation and an upper limit of the number of transactions per unit period during market price depreciation. Then, the prediction device can be configured to output an upper limit which is larger of those predicted upper limits.

Specifically, the prediction device can be configured to predict the upper limit (the first upper limit) of the fluctuation amount of the number of transactions per unit period associated with market price fluctuations during market price appreciation and the upper limit (the second upper limit) of the fluctuation amount of the number of transactions per unit period associated with market price fluctuations during market price depreciation, based on the calculated value by the second confidence interval endpoint calculation device and the first and second basic fluctuation amounts.

Also, the prediction device can be configured to predict an upper limit (the third upper limit) of the number of transactions per unit period when market price fluctuations do not exist, based on the calculated value by the first confidence interval endpoint calculation device. Then, the prediction device can be configured to predict a value obtained by adding the predicted first upper limit to the predicted third upper limit to be an upper limit of the number of transactions per unit period during market price appreciation, and to predict a value obtained by adding the predicted second upper limit to the third upper limit to be an upper limit of the number of transactions per unit period during market price depreciation.

Also, the prediction device may be configured to predict the upper limit of the number of transactions per unit period without using a concept of a confidence interval.

For example, the prediction device can be configured to include a transactions distribution calculation device and a fluctuation amount distribution calculation device, which will be described below.

The transactions distribution calculation device is a device that calculates a probability distribution of the basic number of transactions, based on the basic number of transactions for each unit period. On the other hand, the fluctuation amount distribution calculation device is a device that calculates a probability distribution of the market price fluctuation amount, based on the market price fluctuation amount for each unit period.

That is, the prediction device calculates, for each combination (R, G) of a value R and a value G, an occurrence probability P(R)·P(G) of the number of transactions Es=(R+K·G) per unit period corresponding to the combination, based on an occurrence probability P(R) for each value R of the basic number of transactions identified from the probability distribution of the basic number of transactions, an occurrence probability P(G) for each value G of the market price fluctuation amount identified from the probability distribution of the market price fluctuation amount, and a value K of the basic fluctuation amount.

Then, the upper limit of the number of transactions per unit period for the specific type of transaction is predicted based on a cumulative probability of the number of transactions Es per unit period, which is calculated by accumulating the occurrence probability P(R)·P(G). The cumulative probability changes in accordance with the number of transactions Es per unit period, which functions as a variable. The cumulative probability can be calculated by accumulating the occurrence probability P(R)·P(G) for each combination (R, G), in ascending order of the number of transactions Es per unit period, up to a value of the number of transactions Es per unit period corresponding to the variable.

A minimum value of the number of transactions Es per unit period in a range where the cumulative probability is greater than a specific probability is predicted to be the upper limit of the number of transactions per unit period for the specific type of transaction.

In the method of predicting an upper limit of the number of transactions per unit period using a confidence interval, the predicted value is calculated on the assumption that the distribution of the basic number of transactions and the distribution of the market price fluctuation amount are a normal distribution. Therefore, when the actual distribution is significantly different from a normal distribution, prediction accuracy deteriorates.

On the other hand, according to the present method of predicting an upper limit of the number of transactions per unit period using a cumulative probability, it is not presumed that the distribution of the basic number of transactions and the distribution of the market price fluctuation amount are a normal distribution. Therefore, even when the number of samples is limited, and the distribution of the basic number of transactions and the distribution of the market price fluctuation amount do not follow a normal distribution, it is possible to accurately predict the upper limit.

Also, when the basic fluctuation amount calculation device is configured to calculate the first and second basic fluctuation amounts, the prediction device can be configured as below.

That is, the prediction device uses a value KH of the first basic fluctuation amount as the value K when the value G is positive, and uses a value KL of the second basic fluctuation amount as the value K when the value G is negative. Accordingly the number of transactions Es=(R+K·G) per unit period may be calculated for each of the combination (R, G). At the same time, the occurrence probability P(R)·P(G) of the number of transactions Es per unit period may be calculated. Then, a minimum value of the number of transactions Es per unit period in a range where the cumulative probability is greater than a specific probability may be predicted to be the upper limit of the number of transactions per unit period for the specific type of transaction.

In addition, for inhibiting prediction accuracy of the upper limit from deteriorating due to the quality of a sample data, it is desirable that each of the transactions distribution calculation device and the fluctuation amount distribution calculation device is configured to calculate the corresponding probability distribution with the action of correction to show unimodality.

Specifically, the transactions distribution calculation device can be configured to calculate the probability distribution of the basic number of transactions, while making a correction so that the occurrence probability P(R) is monotonically non-increasing in an interval in which the basic number of transactions is larger than that having the highest occurrence probability P(R). In calculating the probability distribution described above, a correction can be also made so that the occurrence probability P(R) is monotonically non-decreasing in an interval in which the basic number of transactions is smaller than that having the highest occurrence probability P(R).

In calculating the probability distribution as described above, the transactions distribution calculation device can correct a frequency distribution of the basic number of transactions identified from the basic number of transactions for each unit period so that the frequency is monotonically non-increasing in an interval in which the basic number of transactions is larger than that having the highest frequency. Also, the frequency distribution of the basic number of transactions can be corrected so that the frequency is monotonically non-decreasing in an interval in which the basic number of transactions is smaller than that having the highest frequency. Then, by transforming the frequency distribution after correction into a probability distribution, the probability distribution of the basic number of transactions showing unimodality can be calculated.

The frequency distribution (and the probability distribution) of the basic number of transactions may show multimodality due to sampling error. Therefore, by correcting the frequency distribution as described above to obtain a probability distribution, prediction accuracy with respect to the upper limit can be improved.

Similarly, the fluctuation amount distribution calculation device can be configured to calculate a probability distribution of the market price fluctuation amount, while making a correction so that the occurrence probability P(G) is monotonically non-increasing in an interval in which the market price fluctuation amount is larger than that having the highest occurrence probability P(G). In calculating the probability distribution as described above, a correction can be also made so that the occurrence probability P(G) is monotonically non-decreasing in an interval in which the market price fluctuation amount is smaller than that having the highest occurrence probability P(G).

For example, the fluctuation amount distribution calculation device can correct the frequency distribution of the market price fluctuation amount so that the frequency is monotonically non-increasing in an interval in which the market price fluctuation amount is larger than that having the highest frequency. Also, a correction can be made so that the frequency is monotonically non-decreasing in an interval in which the market price fluctuation amount is smaller than that having the highest frequency. Then, by transforming the frequency distribution after correction into a probability distribution, the probability distribution of the market price fluctuation amount showing unimodality can be calculated.

In addition, the basic fluctuation amount calculation device can be configured to calculate the basic fluctuation amount by performing a linear regression analysis of the number of transactions and the market price fluctuation amount for each unit period identified from the sample data.

Specifically, when the first and second basic fluctuation amounts are calculated, the basic fluctuation amount calculation device can be configured to calculate the first basic fluctuation amount by performing a linear regression analysis of the number of transactions and the market price fluctuation amount for each unit period in the first period, and to calculate the second basic fluctuation amount by performing a linear regression analysis of the number of transactions and the market price fluctuation amount for each unit period in the second period.

By calculating the basic fluctuation amount using a linear regression analysis, the basic fluctuation amount can be calculated with high accuracy.

Also, when the number of users allowed to use the system (the number of clients allowed to request a transaction to the system) changes, increase and decrease in the number of users influence the increase and decrease in the number of transactions. Therefore, in adjusting resources in the system described above, it is preferable to predict an upper limit of the number of transactions per unit period per user.

That is, the acquisition device is desirably configured to acquire, as a sample data, the sample data from which the number of transactions per user for each unit period in the past and the market price fluctuation amount for each unit period in the past can be identified.

For example, the sample data can be configured to include, for each unit period, information on the number of users allowed to use the system in the period, together with information on the number of transactions in the period. In this case, the number of transactions per user can be identified by dividing the number of transactions in the period by the total number of users allowed to use the system in the period.

Also, the basic fluctuation amount calculation device is desirably configured to calculate, as a basic fluctuation amount, a fluctuation amount of the number of transactions per user relative to the market price fluctuation amount, based on the number of transactions per user and the market price fluctuation amount for each unit period identified from the sample data. The term “the fluctuation amount of the number of transactions per user relative to the market price fluctuation amount” is defined by, for example, a fluctuation amount of the number of transactions per unit period per user when the market price fluctuation amount per unit period fluctuates by unit amount.

Also, the basic transactions calculation device is desirably configured to calculate, for each unit period, the number of transactions per user in the period on an assumption that market price fluctuations do not exist, based on the basic fluctuation amount, and the number of transactions per user and the market price fluctuation amount for each unit period.

Then, the prediction device is desirably configured to predict, as an upper limit of the number of transactions per unit period for the specific type of transaction, the upper limit of the number of transactions per unit period per user.

By predicting the upper limit and outputting the predicted value, an administrator of the transaction system can easily and adequately adjust resources of the system in consideration of the prospected increased number of users.

Also, the prediction apparatus is desirably configured to include a necessary capacity calculation device. The necessary capacity calculation device calculates a recording capacity Z, which is necessary for the information processing system executing the processing relating to the specific type of transaction, by a formula Z=Q1+D·Q2·Q3, and outputs the calculated recording capacity Z. Here, Q1 means a recording capacity (a fixed necessary volume) Q1 required by the information processing system regardless the number of transactions and the number of users. Also, Q2 means a predicted value Q2 for an upper limit of the number of transactions per unit period per user. In addition, Q3 means an assumed number of users Q3, and D means an increase ratio D of the necessary recording capacity per transaction.

By providing the necessary capacity calculation device as described above, resources of the information processing system can be easily adjusted.

Also, a function as each device possessed by the prediction apparatus according to the second aspect can be realized by making a computer execute a program. The program can be recorded in a computer-readable recording medium to be provided to a user. That is, the recording medium can record a program which causes a computer to execute the processing for predicting an upper limit of the number of transactions per unit period for the specific type of transaction. The processing includes each procedure corresponding to the acquisition device, the basic fluctuation amount calculation device, the basic transactions calculation device and the prediction device. In addition, the idea corresponding to the prediction device according to the second aspect can be applied to an invention of the prediction method.

Also, for a stable operation of the system executing the above-mentioned job (such as a transaction) while inhibiting an excess investment, it is preferable to estimate a throughput necessary for the system by predicting an upper limit of the number of job executions per short time period.

The prediction apparatus in the third aspect of the present invention is a prediction apparatus for predicting an upper limit of the momentary number of jobs. The momentary number of jobs is the number of job executions in a short time period in the system executing a job responding to a request from outside. The prediction apparatus includes an acquisition device, a jobs distribution calculation device, a concentration ratio distribution calculation device, and a prediction device, each of which is described below.

The acquisition device acquires a sample data regarding jobs, from which the number of job executions for each unit period in the past and a concentration ratio for each unit period in the past can be identified.

The “concentration ratio” as described herein refers to a ratio of the largest momentary number of jobs in a unit period to the number of job executions in the unit period.

On the other hand, the jobs distribution calculation device calculates a probability distribution of the number of job executions, based on the number of job executions for each unit period identified from the sample data acquired by the acquisition device. Also, the concentration ratio distribution calculation device calculates a probability distribution of the concentration ratio, based on the concentration ratio for each unit period identified from the sample data.

Then, the prediction device predicts an upper limit of the momentary number of jobs, based on an occurrence probability P(A) for each value A of the number of job executions identified from the probability distribution of the number of job executions, and an occurrence probability P(B) for each value B of the concentration ratio identified from the probability distribution of the concentration ratio. Then the prediction device outputs the predicted upper limit.

According to the prediction apparatus configured as described above, the upper limit of the momentary number of jobs to be realistically considered, from which the momentary number of jobs with fully low occurrence possibility is excluded, can be adequately predicted, based on the probability distributions of the number of job executions and the concentration ratio.

As a result, according to this prediction apparatus, the throughput of a system (an information processing system) can be set to a necessary and sufficient extent, while inhibiting an excess investment in the system.

Specifically, the prediction device can be configured to calculate, for each combination (A, B) of a value A and a value B, an occurrence probability P(A)·P(B) of the momentary number of jobs Qs=A·B corresponding to the combination, based on an occurrence probability P(A) for each value A of the number of job executions and an occurrence probability P(B) for each value B of the concentration ratio. Then, the prediction device can be configured to predict an upper limit of the momentary number of jobs, based on a cumulative probability of the momentary number of jobs Qs.

The cumulative probability changes in accordance with the momentary number of jobs Qs, which functions as a variable. The cumulative probability is calculated by accumulating the occurrence probability P(A)·P(B) for each combination (A, B), in ascending order of the momentary number of jobs Qs, up to the value of the momentary number of jobs Qs corresponding to the variable.

For example, the prediction device can be configured to predict a minimum value of the momentary number of jobs Qs in a range where the cumulative probability is greater than a specific probability to be an upper limit of the momentary number of jobs.

Also, the jobs distribution calculation device and the concentration ratio distribution calculation device can be respectively configured to calculate the corresponding probability distribution with an action of correction to show unimodality. By making a correction described above, prediction accuracy is inhibited from deteriorating due to the quality of a sample data.

Also, when the above-mentioned invention is applied to the system executing a transaction responding to a request from outside as a job, the prediction device can be configured below. That is the prediction device can be configured to predict, as an upper limit of the momentary number of jobs, the upper limit of the momentary number of transactions which is the number of transactions in a short time period in the system.

In addition, when the present invention is used for an information processing system, in which an operation unit executes jobs, the prediction apparatus is desirably configured to include an operation units calculation device.

The operation units calculation device as described herein is a device that calculates the number of operation units necessary for the information processing system, based on the number of jobs which can be simultaneously processed per operation unit, and the upper limit of the momentary number of jobs predicted by the prediction device. Furthermore, the device outputs the calculated number of operation units.

By configuring the prediction apparatus as described above, a manager of an information processing system can adequately adjust the number of operation units to be mounted in the information processing system, based on the calculated number of operation units.

Furthermore, a function as each device possessed by the prediction apparatus in the third aspect can be realized by making a computer execute a program. The program can be recorded in a computer-readable recording medium to be provided to a user. That is, the recording medium can record a program which causes a computer to execute the processing of predicting an upper limit of the momentary number of jobs. The processing includes the procedures corresponding to the acquisition device, the jobs distribution calculation device, the concentration ratio distribution calculation device, and the prediction device. In addition, the idea corresponding to the prediction apparatus according to the third aspect can be applied to the invention of the prediction method.

Also, when an upper limit of the momentary number of jobs (the momentary number of transactions) for the specific type of transaction involving market prices is predicted, the prediction apparatus is preferably configured to predict the upper limit, in consideration of fluctuation of the number of transactions in response to fluctuation of market prices.

A prediction apparatus in the fourth aspect of the present invention is a prediction apparatus for predicting an upper limit of the momentary number of transactions for a specific type of transaction involving market prices therein. The prediction apparatus includes an acquisition device, a basic fluctuation amount calculation device, a basic transactions calculation device, a transactions distribution calculation device, a fluctuation amount distribution calculation device, a concentration ratio distribution calculation device, and a prediction device, each of which is described below.

The acquisition device acquires a sample data regarding the specific type of transaction, from which the number of transactions for each unit period in the past, the market price fluctuation amount for each unit period in the past and the concentration ratio for each unit period in the past can be identified. The “concentration ratio” as described herein refers to a ratio of the largest momentary number of transactions in a unit period to the number of transactions for the period.

On the other hand, the basic fluctuation amount calculation device calculates the basic fluctuation amount that is a fluctuation amount of the number of transactions relative to the market price fluctuation amount, based on the number of transactions and the market price fluctuation amount for each unit period identified from the sample data acquired by the acquisition device. Then, the basic transactions calculation device calculates the basic number of transactions for each unit period, based on the calculated basic fluctuation amount, and the number of transactions and the market price fluctuation amount for the above unit period. The basic number of transactions is the number of transactions per unit period, which is calculated on an assumption that market price does not fluctuate.

Then, the transactions distribution calculation device calculates a probability distribution of the basic number of transactions, based on the basic number of transactions for each unit period. The fluctuation amount distribution calculation device calculates a probability distribution of the market price fluctuation amount, based on the market price fluctuation amount for each unit period. Then, the concentration ratio distribution calculation device calculates a probability distribution of the concentration ratio, based on the concentration ratio for each unit period.

Then, the prediction device predicts the upper limit of the momentary number of transactions, based on an occurrence probability P(R) for each value R of the basic number of transactions identified from the probability distribution of the basic number of transactions, an occurrence probability P(G) for each value G of the market price fluctuation amount identified from the probability distribution of the market price fluctuation amount, an occurrence probability P(B) for each value B of the concentration ratio identified from the probability distribution of the concentration ratio, and a value K of the basic fluctuation amount. Then, the prediction device outputs the predicted upper limit.

According to the prediction device configured as above, an upper limit of the momentary number of transactions can be adequately calculated, in consideration of the influence of market price fluctuations. Therefore, according to this invention, an efficient operation of the system can be realized while inhibiting an excess investment in the system performing a transaction.

Specifically, the prediction device can be configured to calculate, for each combination (R, G, B) of values R, G and B, an occurrence probability P(R)·P(G)·P(B) of the momentary number of transactions Qs=(R+K·G)·B corresponding the combination. Furthermore, the prediction device can be configured to predict the upper limit of the momentary number of transactions for the specific type of transaction, based on a cumulative probability of the momentary number of transactions Qs.

The cumulative probability changes in accordance with the momentary number of transactions Qs, which functions as a variable. The cumulative probability is calculated by accumulating the occurrence probability P(R)·P(G)·P(B) for each combination (R, G, B), in ascending order of the momentary number of transactions Qs, up to a value of the momentary number of transactions Qs corresponding to the variable.

The prediction device can be configured to, for example, predict a minimum value of the momentary number of transactions Qs in a range where the cumulative probability is greater than a specific probability to be the upper limit of the momentary number of transactions for the specific type of transaction.

Also, for inhibiting prediction accuracy from deteriorating due to the quality of a sample data, the transactions distribution calculation device, the fluctuation amount distribution calculation device and the concentration ratio distribution calculation device are preferably configured to calculate the respective probability distributions with an action of correction to show unimodality.

In calculating the probability distribution as described above, the concentration ratio distribution calculation device can correct a frequency distribution of the concentration ratio identified from the concentration ratio for each unit period, so that the frequency is monotonically non-increasing in an interval in which the concentration ratio is larger than that having the highest frequency. Also, a correction can be made so that the frequency is monotonically non-decreasing in an interval in which the concentration ratio is smaller than that having the highest frequency. Then, by transforming the frequency distribution after correction to a probability distribution, the probability distribution of the concentration ratio showing unimodality can be calculated.

It is ideal that the respective frequency distributions and the respective probability distributions of the basic number of transactions, the market price fluctuation amount and the concentration ratio show unimodality. Therefore, by obtaining the probability distribution as described above, an upper limit can be further adequately calculated.

In addition, the prediction apparatus can include an operation units calculation device. The operation units calculation device calculates the number of operation units necessary for the information processing system executing the processing for the specific type of transaction, based on the number of transactions, which can be simultaneously processed per operation unit, and the upper limit of the momentary number of transactions predicted by the prediction device. Then, the operation units calculation device outputs the calculated number of operation units.

In addition, the prediction apparatus can be configured to predict, as an upper limit of the momentary number of transactions, an upper limit of the momentary number of transactions per user. In this case, the acquisition device can be configured to acquire a sample data from which the number of transactions per user for each unit period can be identified.

Also, the operation units calculation device can be configured to calculate the number of operation units, based on a predetermined assumed number of users, the number of transactions which can be simultaneously processed per operation unit, and the upper limit of the momentary number of transactions per user predicted by the prediction device.

For example, the operation units calculation device can be configured to calculate the number of operation units by a formula Z=Qz·U/Ap. In the formula, Z represents the number of operation units, U represents the assumed number of users, Ap represents the number of transactions which can be simultaneously processed per operation unit, and Qz represents the upper limit of the momentary number of transactions per user predicted by the prediction device.

An upper limit of the momentary number of transactions based on the number of future potential users can be obtained simply by multiplying the upper limit of the momentary number of transactions per user by the assumed number of users. As a result, the necessary number of operation units can be calculated simply in consideration of the number of future potential users. Information on the assumed number of users can be acquired from an operator of the prediction apparatus through an input device.

Also, a function as each device possessed by the prediction apparatus in the fourth aspect can be realized by making a computer execute a program. The program can be recorded in a computer-readable recording medium to be provided to a user. That is, the recording medium can record a program which causes a computer to execute the processing of predicting an upper limit of the momentary number of transactions for a specific type of transaction involving market prices. The processing includes the procedures each corresponding to the acquisition device, the basic fluctuation amount calculation device, the basic transactions calculation device, the transactions distribution calculation device, the fluctuation amount distribution calculation device, the concentration ratio distribution calculation device, and the prediction device.

In addition, the idea corresponding to the prediction apparatus according to the fourth aspect can be applied to an invention of the prediction method.

### BRIEF DESCRIPTION OF THE DRAWINGS

Examples of the present invention will be described below, with reference to the accompanying drawings.

FIG. 1 is a block diagram showing structure of a prediction apparatus according to embodiments of the present invention.

FIG. 2 is a schematic diagram regarding a foreign exchange transaction system.

FIG. 3A and FIG. 3B are flowcharts showing prediction processing executed by an operation device according to the first embodiment.

FIG. 4 is a diagram showing an example of structure of a transaction performance data according to the first embodiment.

FIG. 5A is a scatter diagram showing an example of the relationship between the number of transactions and the market price fluctuation amount during market price depreciation, and FIG. 5B is a scatter diagram showing an example of the relationship between the number of transactions and the market price fluctuation amount during market price appreciation.

FIG. 6 is a diagram showing an example of structure of a list of the basic number of transactions.

FIG. 7A is a diagram showing an example of a frequency distribution of the basic number of transactions, and FIG. 7B is a diagram showing an example of the normal probability plot of the basic number of transactions.

FIG. 8 is a diagram showing an example of a range of the predicted number of transactions relative to the market price fluctuation amount.

FIG. 9 and FIG. 10 are flowcharts showing prediction processing according to the second embodiment.

FIG. 11A is a diagram showing an example of the frequency distribution of the basic number of transactions before correction, and FIG. 11B is a diagram showing an example of the frequency distribution of the basic number of transactions after correction.

FIG. 12 is a table showing an example of the frequencies and the occurrence probability for each interval of the basic number of transactions.

FIG. 13A is a diagram showing an example of the frequency distribution of the market price fluctuation amount before correction, and FIG. 13B is a diagram showing an example of the frequency distribution of the market price fluctuation amount after correction.

FIG. 14 is a table showing an example of the frequencies and the occurrence probability for each interval of the market price fluctuation amount.

FIG. 15A is a graph showing an example of the relationship between the basic number of transactions and the market price fluctuation amount, and the number of transactions per day, and FIG. 15B is a graph showing an example of the probability distribution of the number of transactions per day.

FIG. 16 is a diagram showing an example of a table in which the number of transactions per day, and the corresponding occurrence probability and cumulative probability are recorded.

FIG. 17 is a flowchart showing prediction processing according to the third embodiment.

FIG. 18 is a diagram showing an example of structure of a transaction performance data according to the third embodiment.

FIG. 19A, FIG. 19B and FIG. 20 are flowcharts showing main processing executed in prediction processing according to the third embodiment.

FIG. 21A is a graph showing an example of the relationship between the basic number of transactions and the market price fluctuation amount, and the number of transactions per day, and FIG. 21B is a graph showing an example of the probability distribution of the number of transactions per day.

FIG. 22A is a diagram showing an example of the frequency distribution of the concentration ratio before correction, FIG. 22B is a diagram showing an example of the frequency distribution of the concentration ratio after correction, and FIG. 22C is a diagram showing an example of the probability distribution of the concentration ratio after correction.

FIG. 23 is a diagram showing an example of structure of a table in which the momentary number of transactions, and the corresponding occurrence probability and cumulative probability are recorded.

FIG. 24 is a graph showing an example of the cumulative probability of the momentary number of transactions.

FIG. 25A and FIG. 25B are a flowcharts showing main processing according to the fourth embodiment.

FIG. 26 is a flowchart showing prediction processing according to the fifth embodiment.

FIG. 27 is a flowchart showing prediction processing according to the sixth embodiment.

### DETAILED DESCRIPTION OF THE PREFERRED EMBODIMENT

### First Embodiment

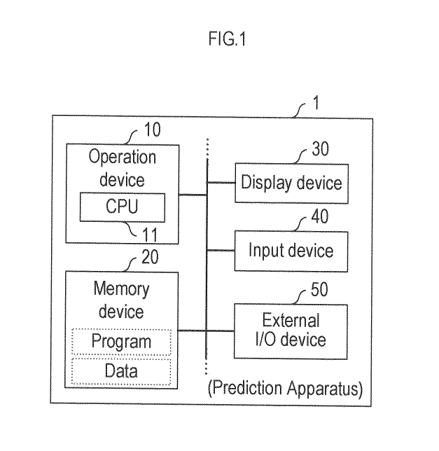

A prediction apparatus 1 according to the present embodiment is configured by installing a dedicated program in a well-known personal computer. The prediction apparatus 1 includes, as shown in FIG. 1, an operation device 10, a memory device 20, a display device 30, an input device 40 and an external I/O device 50. The operation device 10 includes a CPU 11 and other components such as ROM and RAM which are not shown, and executes processing based on various programs. The memory device 20 stores various programs which are executed by the operation device 10 in the CPU 11 and various data which are provided during execution of the programs. For example, the memory device 20 includes a hard disk device.

The display device 30 includes, for example, a liquid crystal display device, and displays a variety of information on the screen in accordance with an instruction from the operation device 10. In addition, the input device includes a user interface such as a keyboard and a pointing device.

The external I/O device 50 is configured to be capable of writing data into an external recording medium and reading data from an external recording medium. For example, the external I/O device 50 includes a drive device, which can read/write data from/into an external recording medium such as a magnetic disk and a DVD, a USB interface, and the like. The external I/O device 50 is used to acquire a sample data necessary for a prediction action from outside.

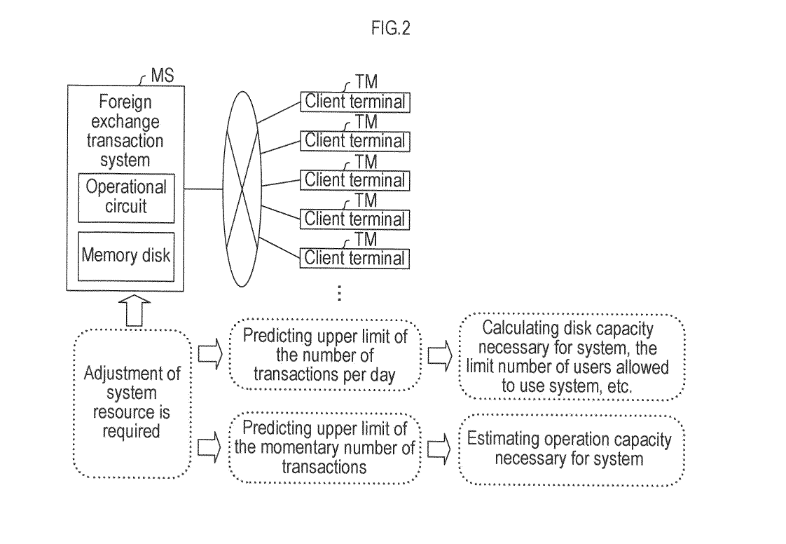

Thereafter, before explaining the detail of the prediction apparatus 1, the structure of a transaction system MS will be explained with reference to FIG. 2. For the transaction system MS, the prediction apparatus 1 predicts an upper limit of the number of transactions per day in the future (that is, an upper limit of the range in which the number of transactions per day fluctuates in the future).

The transaction system MS, for which the prediction apparatus 1 according to the present embodiment predicts the upper limit of the number of transactions, is a transaction system which performs foreign exchange transactions. In the foreign exchange transactions, exchange rates are determined in the market. The transaction system MS, for which a prediction is performed, is a computerized transaction system MS configured as an information processing system for use in, for example, financial facilities. The transaction system MS performs a foreign exchange transaction corresponding to a transaction request transmitted from a client's terminal device TM through a network. Examples of the foreign exchange transactions include a dollar-yen foreign exchange transaction involving a dollar-yen currency exchange, a euro-yen foreign exchange transaction involving a euro-yen currency exchange, and other various foreign exchange transactions.

In the foreign exchange transactions, larger fluctuation of market prices (for example, yen rates) causes the number of transactions to increase. Therefore, for a stable operation of the transaction system MS, it is preferable to adjust resources of the transaction system MS including a computer (a server device) as a component, in consideration of increase of the number of transactions associated with fluctuation of market prices.

Furthermore, in this type of transaction system MS, increasing number of users who are allowed to use the system causes the number of transactions in the whole system to increase. Therefore, it is preferable to adjust resources in consideration of the prospected increased number of users.

The prediction apparatus 1 according to the present embodiment provides information for adequately adjusting resources in consideration of the points mentioned above. As will be described in detail below, the prediction apparatus 1 predicts an upper limit of the number of transactions per day per user, based on the number of transactions (an actual value) per user for each day in the past identified from the transaction performance data, and a market price fluctuation amount (an actual value) for each day identified from the transaction performance data. Based on the predicted result, for example, a system manager adjusts resources of the transaction system MS corresponding to the prospected number of users, thereby inhibiting an excess investment in the transaction system MS and realizing a stable operation of the transaction system MS at low cost.

For ease of discussion, in the prediction apparatus 1 described below, the transaction system MS is presumed to perform only a dollar-yen foreign exchange transaction. Resources of a transaction system capable of executing various types of foreign exchange transaction dealing with different currencies can be adjusted by, for each type of transaction, predicting an upper limit of the number of transactions using procedures similar to the prediction method described below. Resources of the transaction system can be adjusted based on a combined value of the upper limit of the number of transactions of each type.

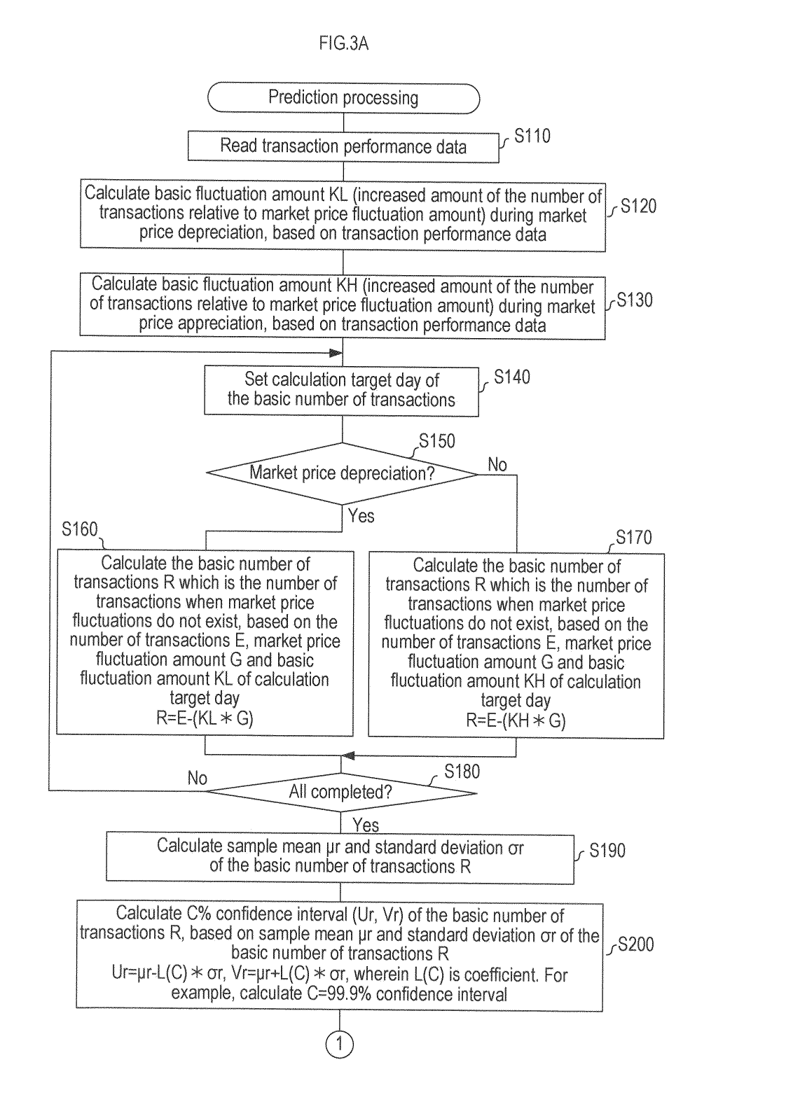

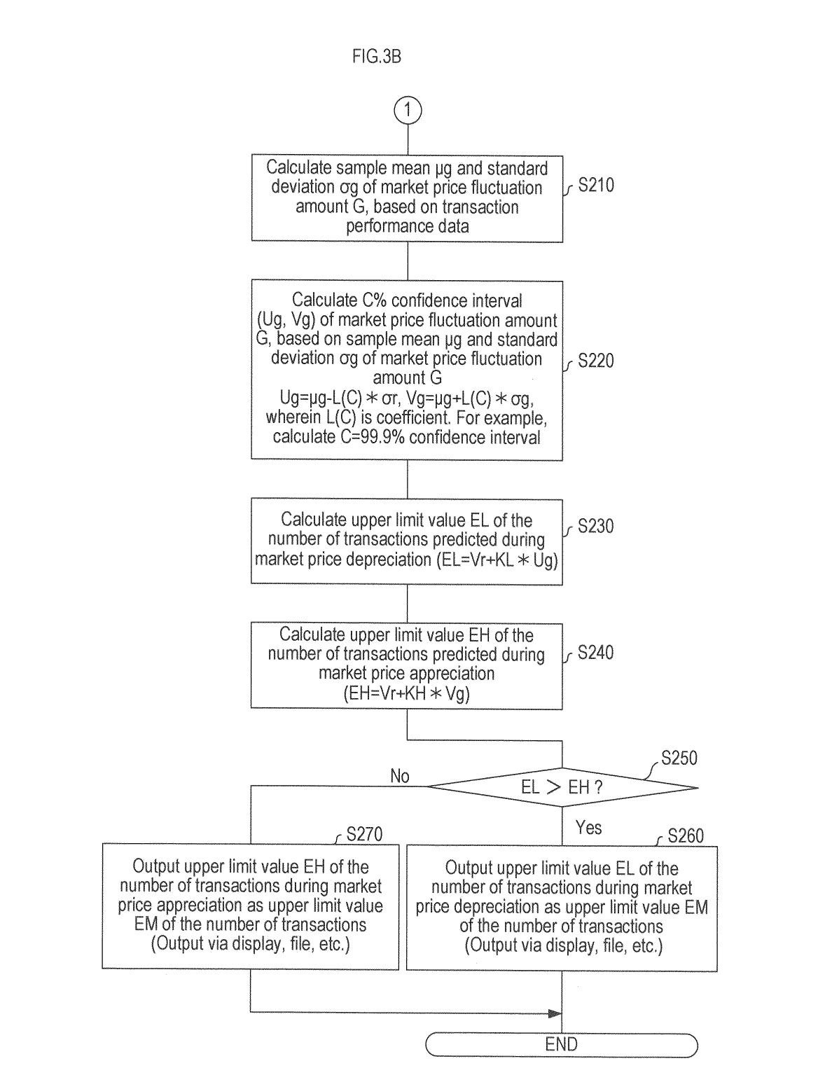

Next, a detailed configuration of the prediction apparatus 1 is explained. The prediction apparatus 1 executes prediction processing shown in FIG. 3A and FIG. 3B, in accordance with an instruction inputted from the input device 40. The prediction apparatus 1 thereby predicts an upper limit of the number of transactions per day per user for a dollar-yen foreign exchange transaction in the transaction system MS. The prediction processing is realized in such a manner that the operation device 10 executes a dedicated program stored in the memory device 20.

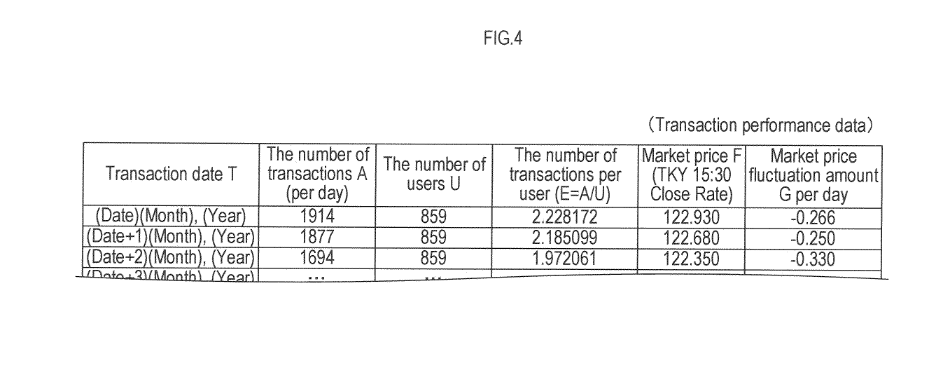

Once the prediction processing is started, the operation device 10 reads the transaction performance data stored in the memory device 20 through the external I/O device 50 (S110). As shown in FIG. 4, the transaction performance data contains a record for each day in a predetermined period (for example, one year) in the past. The record includes a date T, the number of transactions A of the day, the number of users U that is the number of users allowed to use the transaction system MS of the day, the number of transactions E per user of the day, a market price (yen rate) F at a predetermined time T0 of the day, and a market price (yen rate) fluctuation amount G per day of the day.

Of course, the transaction performance data does not need to have the records for all the days in the predetermined period. It is enough to have only the records of the days when the transaction through the transaction system MS is available.

The number of transactions A described in the record represents the total number of transactions (an actual value) per day of the day in the transaction system MS for which a prediction is performed. The number of transactions E is a value obtained by dividing the number of transactions A of the day by the number of users U (E=A/U). It should be noted that the number of transactions E is calculated by dividing the number of transactions A by the total number of users allowed to use the transaction system MS (the number of users U), whether or not the user actually performed a transaction on the day.

The market price fluctuation amount G per day is obtained by subtracting the market price F at the predetermined time T0 of the previous day from the market price F at the predetermined time T0 of the day. The market price F shown in FIG. 4 is a yen rate at T0=15:30 in the Tokyo foreign exchange market. Thus, the transaction performance data is configured as a sample data, from which the number of transactions E per user for each day for a dollar-yen foreign exchange transaction through the transaction system MS and the market price fluctuation amount G per day in the past can be identified.

After reading the transaction performance data in S110, the operation device 10 calculates a basic fluctuation amount KL of the number of transactions E per day per user during market price depreciation (dollar depreciation), based on the read transaction performance data (S120). Furthermore, the operation device 10 calculates the basic fluctuation amount KH of the number of transactions E per day per user during market price appreciation (dollar appreciation) (S130). The basic fluctuation amounts KL and KH as described herein represent an increased amount of the number of transactions E relative to the market price fluctuation amount G (an increased amount of the number of transactions E per day per user when the market price fluctuation amount G per day increases by a unit amount “one yen”). The “market price appreciation” and the “market price depreciation” are expressed by using a dollar as a reference.

In S120 and S130, the basic fluctuation amounts KL and KH are calculated by performing a linear regression analysis of the transaction performance data.

In other words, the basic fluctuation amounts KL and KH are calculated by approximating the distributions of the number of transactions E (actual value) per day per user and the market price fluctuation amount G (actual value) for each day in the past identified from the transaction performance data, by a linear function Y=αX+β (wherein, X corresponds to the market price fluctuation amount G, and Y corresponds to the number of transactions E).

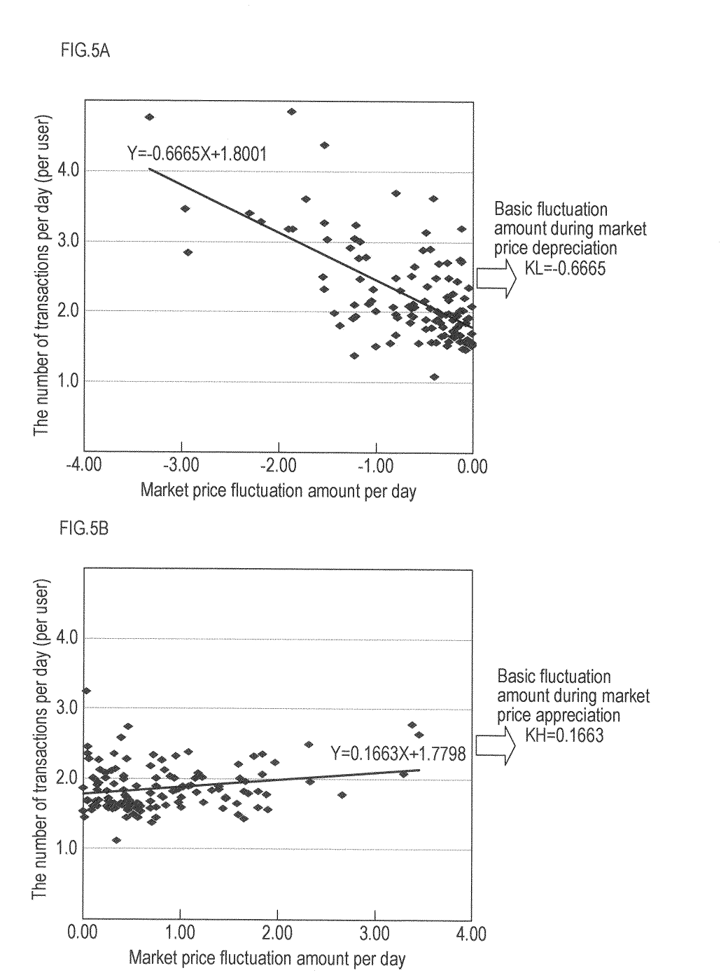

Here, the processing realized by S120 and S130 are conceptually described below. Suppose, for example, that scatter diagrams shown in FIGS. 5A and 5B are obtained by plotting each point corresponding to the number of transactions E and the market price fluctuation amount G, which are represented by each record recorded in the transaction performance data on the coordinate system. In the coordinate system, an x-axis represents the market price fluctuation amount G per day, and a y-axis represents the number of transactions E per day per user. By calculating a linear function Y=αX+β, in which an error from the distribution of these points is minimized, constants α and β are derived. The linear function Y=αX+β can be calculated by the least squares method. In S120 and S130, a value corresponding to the constant α (a coefficient of the linear function) is calculated as the basic fluctuation amounts KL and KH.

In S120, as shown in FIG. 5A, the basic fluctuation amount KL during market price depreciation is calculated, using only the records in which the market price fluctuation amount G represents negative or zero (that is, a group of records for market price depreciation), among a group of records recorded in the transaction performance data. On the other hand, in S130, as shown in FIG. 5B, the basic fluctuation amount KH during market price appreciation is calculated, using only the records in which the market price fluctuation amount G represents positive or zero (that is, a group of records for market price appreciation), among a group of records recorded in the transaction performance data. When the basic fluctuation amounts KL and KH are calculated using plotted numbers of transactions in FIGS. 5A and 5B, the values KL=−0.6665 and KH=0.1663 can be obtained.

When the processing in S120 and S130 is completed, the operation device 10 sets one of the days recorded in the transaction performance data, to be a calculation target day of the basic number of transactions R (S140). By determining whether or not the market price fluctuation amount G represented by the record of the calculation target day, is negative, it is determined whether or not the calculation target day is a day of market price depreciation (S150).

Then, if the calculation target day is a day of market price depreciation (Yes in S150), the processing proceeds to S160. In S160, an increased amount V of the number of transactions E caused by market price fluctuations on that day is estimated to be KL·G, based on the market price fluctuation amount G represented by the record of the calculation target day. The number of transactions (E−V) obtained by subtracting the estimated increased amount V from the actual number of transactions E represented by the record of the calculation target day is calculated as a basic number of transactions R. The basic number of transactions R represents the number of transactions per day per user when the market price fluctuation amount per day is zero.

Specifically, in S160, the basic number of transactions R of the calculation target day is calculated by substituting the number of transactions E per day per user represented by the record of the calculation target day, the market price fluctuation amount G per day represented by the record of the calculation target day, and the basic fluctuation amount KL during market price depreciation calculated in S120, for the following formula:

R=E−KL·G

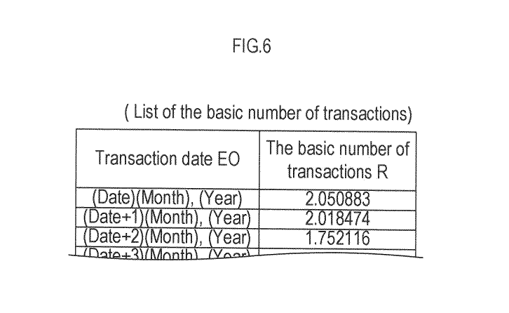

Then, the calculated basic number of transactions R is recorded and thereby stored in the list of the basic number of transactions (see FIG. 6), which is provided in the memory device 20 as a temporary file, together with the date information of the calculation target day. Thereafter, the processing proceeds to S180.

On the other hand, when the market price fluctuation amount G represented by the record of the calculation target day is positive or zero, the operation device 10 determines that the day is a day of market price appreciation (No in S150). In such a case, the processing proceeds to S170. In S170, the basic number of transactions R of the calculation target day is calculated in the same method as in S160, using the basic fluctuation amount KH.

Specifically, in S170, the basic number of transactions R of the calculation target day is calculated by substituting the number of transactions E per day per user represented by the record of the calculation target day, the market price fluctuation amount G per day represented by the record of the calculation target day, and the basic fluctuation amount KH during market price appreciation calculated in S130, for the following formula:

R=E−KH·G

Then, the calculated basic number of transactions R is recorded in the list of the basic number of transactions together with the date information of the calculation target day. The calculated result is thereby stored, and the processing proceeds to S180.

When the processing proceeds to S180, the operation device 10 determines whether or not every basic number of transactions R of each day, on which the record is recorded in the transaction performance data, has been calculated. If not, the processing proceeds to S140. In S140, the day which is not yet set as a calculation target day is newly set as a calculation target day. Then, the processing of S150 and thereafter is executed. By repeating the processing described above, the operation device 10 calculates the basic number of transactions R for each day recorded in the transaction performance data, and records the calculated results in the list of the basic number of transactions.

After every basic number of transactions R of each day on which the record is recorded in the transaction performance data has been calculated and the calculated results has been recorded in the list of the basic number of transactions (Yes in S180), the processing proceeds to S190. In S190, a group of records recorded in the list of the basic number of transactions is taken as a sample group, and a mean pr and a standard deviation or of the basic number of transactions R based on this sample group are calculated.

Then, based on the calculated mean pr and standard deviation or, a confidence interval (Ur, Vr) at a C % confidence level of the basic number of transactions R is calculated. That is, values Ur and Vr corresponding to the confidence interval endpoints are calculated (S200). Here, for example, by setting a confidence level to be 99.9%, the values Ur and Vr corresponding to the endpoints of a 99.9% confidence interval (Ur, Vr) of the basic number of transactions R are calculated. The confidence interval at a C % confidence level of the basic number of transactions R refers to an interval in which the basic number of transactions R of the population is included with C % probability.

The values Ur and Vr can be calculated by the following formulae, wherein L(C) is a coefficient defined by the confidence level.

Ur=μr−L(C)·σr

Vr=μr+L(C)·σr

When the values Ur and Vr corresponding to the endpoints of the 99.9% confidence interval (Ur, Vr) are calculated, L(C)=3.3 can be used.

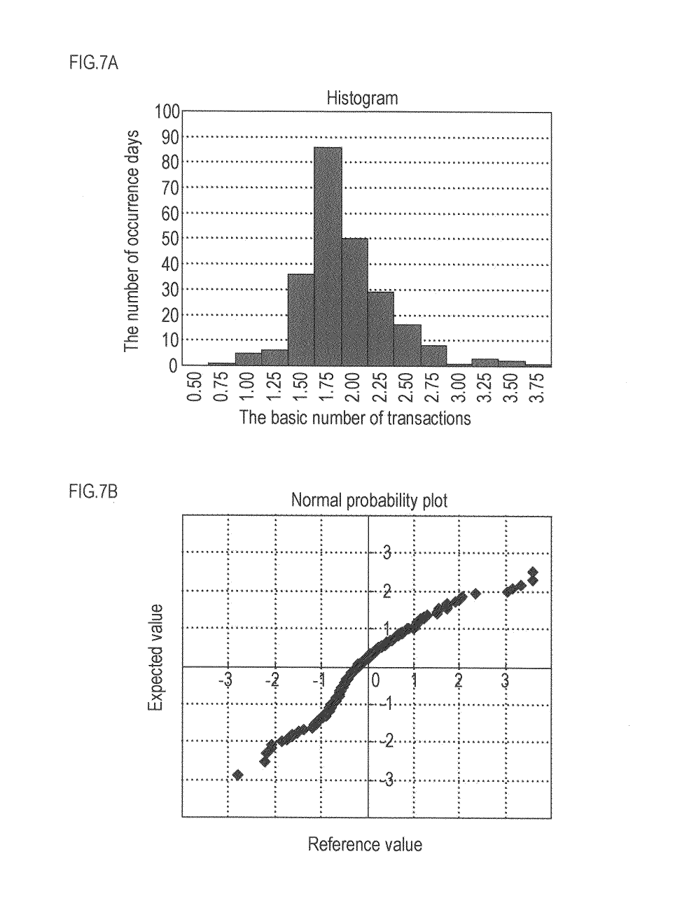

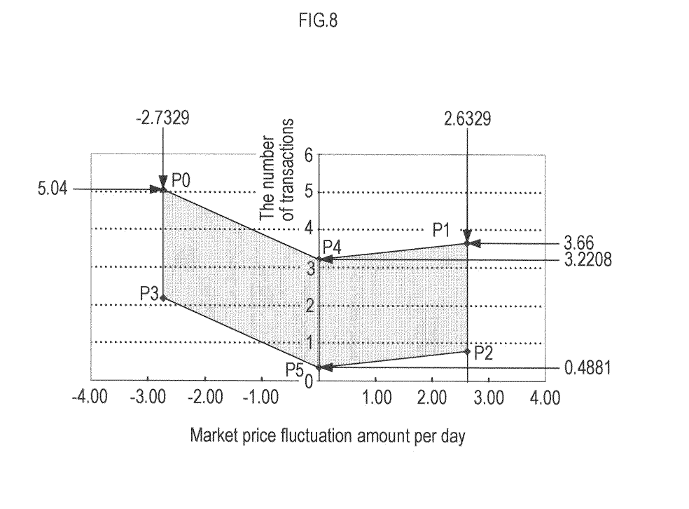

In this connection, obtaining an accurate confidence interval by the above formulae should be based on the premise that a sample group follows a normal distribution. A distribution of the basic number of transactions R, as shown in FIGS. 7A and 7B, can be presumed to be close to a normal distribution. Therefore, here, the confidence interval of the basic number of transactions R is obtained by the above formulae. FIG. 7A is a histogram of the basic number of transactions R based on the sample group shown in FIGS. 5A and 5B, and FIG. 7B is a normal probability plot of the basic number of transactions R based on the sample group shown in FIGS. 5A and 5B.

Since only the value Vr, of the values Ur and Vr, is necessary for the subsequent processing, it is enough to calculate only the value Vr of an upper endpoint (an upper confidence limit) of the confidence interval (Ur, Vr) in S200. The value Vr corresponding to the upper endpoint of the confidence interval (Ur, Vr) indicates an upper limit of the basic number of transactions R in the future. On the other hand, the value Ur corresponding to a lower endpoint (a lower confidence limit) of the confidence interval (Ur, Vr) indicates a lower limit of the basic number of transactions R in the future. Therefore, when an upper limit of the number of transactions per day per user is predicted, calculation of the value Ur is not necessary.

By calculating the values Ur and Vr corresponding to the endpoints of the 99.9% confidence interval (Ur, Vr) of the basic number of transactions R based on samples plotted in scatter diagrams of FIGS. 5A and 5B, the values Ur=0.3580 and Vr=3.2208 can be obtained.

When the processing in S200 is completed, a mean μg and a standard deviation σg of the market price fluctuation amount G are calculated using a group of the market price fluctuation amount G for each day represented by the transaction performance data as a sample group (S210). Then, based on the calculated mean μg and standard deviation σg, values Ug and Vg corresponding to endpoints of the confidence interval (Ug, Vg) at a C % confidence level of the market price fluctuation amount G are calculated (S220).

Here, for example, by setting a confidence level to be 99.9%, the values Ug and Vg corresponding to the endpoints of the 99.9% confidence interval (Ug, Vg) of the market price fluctuation amount G per day can be calculated. The confidence interval (Ug, Vg) at a C % confidence level of the market price fluctuation amount G per day refers to an interval in which the market price fluctuation amount G per day of the population is included with C % probability.

The values Ug and Vg corresponding to the respective endpoints of the confidence interval (Ug, Vg) can be calculated by the following formulae. When the values Ug and Vg corresponding to respective endpoints of the 99.9% confidence interval (Ug, Vg) are calculated, L(C)=3.3 can be used.

Ug=μg−L(C)·σg

Vg=μg+L(C)·σg

Price fluctuations of a marketable commodity such as a foreign exchange follow a normal distribution in general. Here, the market price fluctuation amount G per day, which is a target of calculation of a confidence interval, follows a normal distribution as well. Therefore, the confidence interval can be calculated by the above formulae.

Since the market price fluctuation amount G changes above and below zero, the value Ug corresponding to a lower endpoint of the confidence interval (Ug, Vg) takes a negative value, and indicates a limit of decline in market prices (exchange rate) per day. Also, the value Vg corresponding to an upper endpoint of the confidence interval (Ug, Vg) takes a positive value, and indicates a limit of rise in market prices per day. When the values Ug and Vg corresponding to the endpoints of a 99.9% confidence interval (Ug, Vg) of the market price fluctuation amount G are calculated based on samples plotted in scatter diagrams in FIGS. 5A and 5B, the values Ug=−2.7329 and Vg=2.6329 can be obtained.

When the processing in S220 is completed, an upper limit EL of the number of transactions per day per user on the day of market price depreciation is predicted (S230). Specifically, in S230, the upper limit EL of the number of transactions is calculated by the following formula, based on the value Vr of an upper endpoint of the confidence interval (Ur, Vr) of the basic number of transactions R, the value Ug of a lower endpoint of the confidence interval (Ug, Vg) of the market price fluctuation amount G, and the basic fluctuation amount KL during market price depreciation.

EL=Vr+KL·Ug

In the formula, the first term indicates an upper limit of the basic number of transactions R to be predicted when market price fluctuations do not exit. According to the second term, an upper limit of the increased amount of the number of transactions E caused by market price fluctuations when market prices fluctuate downward is calculated. Therefore, according to the above formula, an upper limit of the number of transactions per day per user to be predicted on the day of market price depreciation is calculated. In the present embodiment, by calculating an upper limit EL of the number of transactions as described above, an upper limit of the number of transactions per day per user on the day of market price depreciation is predicted. In this connection, when an upper limit EL of the number of transactions is calculated based on samples plotted in scatter diagrams in FIGS. 5A and 5B, KL=−0.6665, Ug=−2.7329, and Vr=3.2208 give EL=5.04.

When the processing in S230 is completed, the operation device 10 calculates, similarly to the above processing, an upper limit EH of the number of transactions per day per user to be predicted on the day of market price appreciation (S240).

That is, in S240, an upper limit EH of the number of transactions is calculated by the following formula, based on the value Vr of an upper endpoint of a confidence interval (Ur, Vr) of the basic number of transactions R, the value Vg of an upper endpoint of a confidence interval (Ug, Vg) of the market price fluctuation amount G, and the basic fluctuation amount KH during market price appreciation.

EH=Vr+KH·Vg

In the formula, the first term indicates an upper limit of the basic number of transactions R to be predicted when market price fluctuations do not exit. According to the second term, an upper limit of the increased amount of the number of transactions E caused by market price fluctuations when market prices fluctuate upward is calculated. Therefore, according to the formula, an upper limit of the number of transactions per day per user to be predicted on the day of market price appreciation is calculated. In the present embodiment, by calculating an upper limit EH of the number of transactions as described above, an upper limit of the number of transactions per day per user on the day of market price appreciation is predicted. In this connection, when an upper limit EH of the number of transactions is calculated based on samples plotted in scatter diagrams in FIGS. 5A and 5B, KH=0.1663, Vg=2.6329, and Vr=3.2208 give EH=3.66.

When the processing in S240 is completed, the operation device 10 determines whether or not the upper limit EL of the number of transactions during market price depreciation is greater than the upper limit EH of the number of transactions during market price appreciation, based on the upper limits EL and EH of the number of transactions calculated in S230 and S240 (S250).

If it is determined that the upper limit EL of the number of transactions during market price depreciation is greater than the upper limit EH of the number of transactions during market price appreciation (Yes in S250), the upper limit EL of the number of transactions during market price depreciation is displayed on the display device 30, as an upper limit EM of the number of transactions per day per user to be predicted in the future in the transaction system MS. At the same time, a log file describing the upper limit EM of the number of transactions is generated, and the generated log file is stored in the memory device 20. Here, by generating the log file to store the generated log file in the memory device 20, an operator of the prediction apparatus 1 can check the predicted results again later through other application programs installed in the prediction apparatus 1. Thereafter, the operation device 10 terminates the prediction processing.

On the other hand, if the determination in S250 is No, an upper limit EH of the number of transactions during market price appreciation is displayed on the display device 30, as an upper limit EM of the number of transactions in the transaction system MS (S270). At the same time, a log file describing an upper limit EM of the number of transactions is generated, and the generated log file is stored in the memory device 20. Thereafter, the operation device 10 terminates the prediction processing.

In S260 and S270, a graph in a format shown in FIG. 8 may be displayed on the display device 30 together with the upper limit EM of the number of transactions. Thus, the range of the number of transactions E per day per user to be predicted for each market price fluctuation amount may be visually displayed to an operator of the prediction apparatus 1.

A point P0 shown in FIG. 8 corresponds to an upper limit EL of the number of transactions during market price depreciation obtained in S230. A point P1 corresponds to an upper limit EH of the number of transactions during market price appreciation obtained in S240. A point P2 corresponds to a lower limit EHL of the number of transactions per day to be predicted when market prices swing toward market price appreciation to a maximum extent. This lower limit EHL of the number of transactions can be calculated by the following formula:

EHL=Ur+KH·Vg

Furthermore, a point P3 corresponds to a lower limit ELL of the number of transactions per day to be predicted when market prices swing toward market price depreciation to a maximum extent. This lower limit ELL of the number of transactions can be calculated by the following formula:

ELL=Ur+KL·Ug

In addition, a point P4 corresponds to the value Vr, and a point P5 corresponds to the value Ur. The area defined by connecting each of these points P0-P4-P1-P2-P5-P3 (shaded area in FIG. 8) indicates a variation range of the number of transactions E per day per user in the transaction system MS predicted by the prediction processing. The probability with which the number of transactions E is included in this range is C2%.

According to the prediction apparatus 1 of the present embodiment, which has been described above, a linear regression analysis of the transaction performance data is performed to calculate the basic fluctuation amounts KL and KH. Then, the basic number of transactions R for each day is calculated based on the calculated basic fluctuation amounts KL and KH. Furthermore, based on a distribution of the basic number of transactions R, an upper limit Vr of the number of transactions when market price fluctuations do not exist is predicted. On the other hand, based on a distribution of the market price fluctuation amount identified from the transaction performance data, limits Ug and Vg of the market price fluctuation amount per day is predicted. Then, based on the values Vr, Ug, Vg, KL and KH, an upper limit EM of the number of transactions per day per user is predicted.

Therefore, according to the prediction apparatus 1, by statistically analyzing the transaction performance data in a proper manner, it is possible to predict an upper limit EM of the number of transactions per day per user with high accuracy. As a result, by utilizing the prediction apparatus 1, it is possible to precisely estimate resources necessary for the transaction system MS. This inhibits an excess investment in the system for a stable operation thereof. Accordingly, the transaction system MS can be stably operated with lower cost.

For example, for a stable operation of the transaction system MS, a necessary disk capacity can be calculated by the following formula, using the upper limit EM of the number of transactions:

“Necessary disk capacity”=K1×EM×“Prospected number of users”+K2

The constants K1 and K2 can be previously obtained by, for example, performing an operation test of the transaction system MS. The constant K1 is a necessary disk capacity per transaction, and the constant K2 is a disk capacity fixedly necessary for the transaction system MS. The “prospected number of users” as described herein is a prospected value of the number of users in the future.

For a stable operation of the transaction system MS, the system needs to be rebooted at the time when disk fragmentation develops to a certain degree. In such a case, if an upper limit EM of the number of transactions is calculated by the prediction apparatus 1, the fragmentation progress speed can be estimated with a high degree of accuracy using the calculated value EM, thereby making it possible to effectively reboot the system.

In addition, for a stable operation of the transaction system MS, it is also important to understand the number of users with which the stable operation can be performed (hereinafter referred to as “the allowable number of users”). This allowable number of users can be calculated by the following formula:

“Allowable number of users”=“Originally assumed number of users”×“Originally assumed number of transactions per day per user”÷EM

In the formula, “Originally assumed number of users” is the number of users originally assumed when the transaction system MS is designed. Also, “Originally assumed number of transactions per day per user” is the number of transactions per day per user originally assumed when the transaction system MS is designed. Furthermore, “EM” is an upper limit EM of the number of transactions, which is a predicted value of the number of transactions per day per user by the prediction apparatus 1.

Also, according to the present embodiment, the upper limit EM of the number of transactions per day per user is predicted. Therefore, even in the environment in which the number of users who are allowed to use the transaction system MS changes, resources of the transaction system MS can be adequately adjusted, in consideration of the increased number of users which is prospected in the future.

Also, the increased amount of the number of transactions caused by market price fluctuations is predicted to be different between during market price appreciation and during market price depreciation. Under such a circumstance, according to the present embodiment, the basic fluctuation amount KH during market price appreciation and the basic fluctuation amount KL during market price depreciation are calculated respectively. Then, the basic number of transactions R is calculated using the calculated results. Therefore, the upper limit EM of the number of transactions per day per user can be predicted more accurately than when the basic number of transactions R is calculated in disregard of differences in the trends of change in the number of transactions between in the market price appreciation and in the market price depreciation.

By the way, for the prediction apparatus 1, a variation described below is possible. For example, when a confidence interval (Ur, Vr) is calculated, the sample group needs to show normality. Therefore, in the stage before execution of S200, a histogram and/or a normal probability plot as shown in FIGS. 7A and 7B may be displayed on the display device 30 such that an operator can determine whether or not the sample group is acceptable. Then, the prediction apparatus 1 may be configured so that if the operator performs an operation to cancel the execution of the subsequent processing, the prediction processing is terminated. Furthermore, the prediction apparatus 1 may be configured so that if the operator performs an operation to permit execution of the subsequent processing, the processing proceeds to the subsequent processing.

Also, the prediction apparatus 1 may be configured to calculate the “necessary disk capacity” and display the calculated result on the display device 30. That is, in S260 and S270, based on the “Prospected number of users” previously inputted by an operator through the input device 40, as well as constants K1 and K2, the necessary disk capacity may be calculated by the above-mentioned formula:

“Necessary disk capacity”=K1×EM×“Prospected number of users”+K2

Then the calculated result may be displayed on the display device 30.

Furthermore, a log file describing the “necessary disk capacity” may be stored in the memory device 20 together with an upper limit EM of the number of transactions.

In this connection, the correspondence relation between the terms regarding the prediction apparatus 1 of the first embodiment is described as below. The function realized by the processing of S110 corresponds to an example of the function realized by the acquisition device (procedure). The function realized in the processing of S120 and S130 corresponds to an example of the function realized by the basic fluctuation amount calculation device (procedure). The function realized by the processing of S140 to S180 corresponds to an example of the function realized by the basic transactions calculation device (procedure), and the function realized by the processing of S190 to S270 corresponds to an example of the function realized by the prediction device (procedure). In particular, the function realized by the processing of S190 and S200 corresponds to an example of the function realized by the first confidence interval endpoint calculation device (procedure), and the function realized by the processing of S210 and S220 corresponds to an example of the function realized by the second confidence interval endpoint calculation device (procedure).

### Second Embodiment

Next, a prediction apparatus 1 according to the second embodiment will be described. The prediction apparatus 1 according to the second embodiment predicts, unlike the first embodiment, an upper limit EM of the number of transactions per day per user in the future in the transaction system MS, without using a confidence interval. In the first embodiment, since it is presumed that the sample group shows a normal distribution, if the sample group is significantly different from the normal distribution, it may be difficult to accurately obtain an upper limit EM of the number of transactions. On the other hand, according to the second embodiment described below, which does not use a confidence interval, for example, even if the number of samples is not enough and the sample group is different from the normal distribution, an upper limit EM of the number of transactions can be adequately calculated.

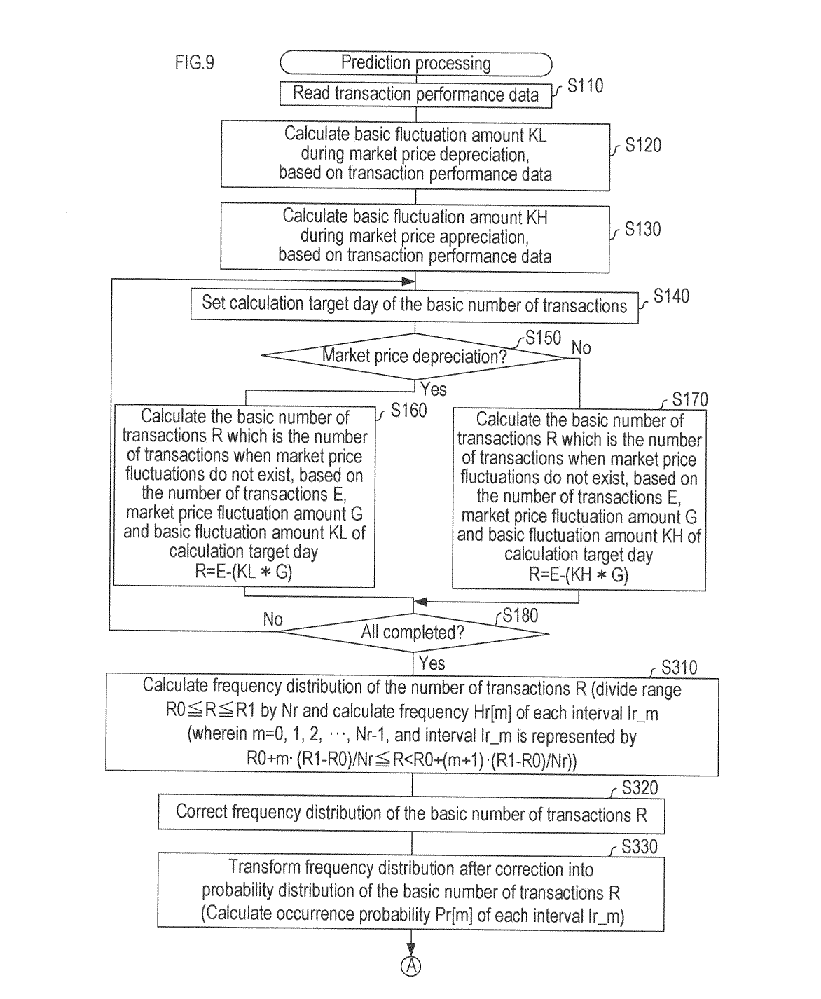

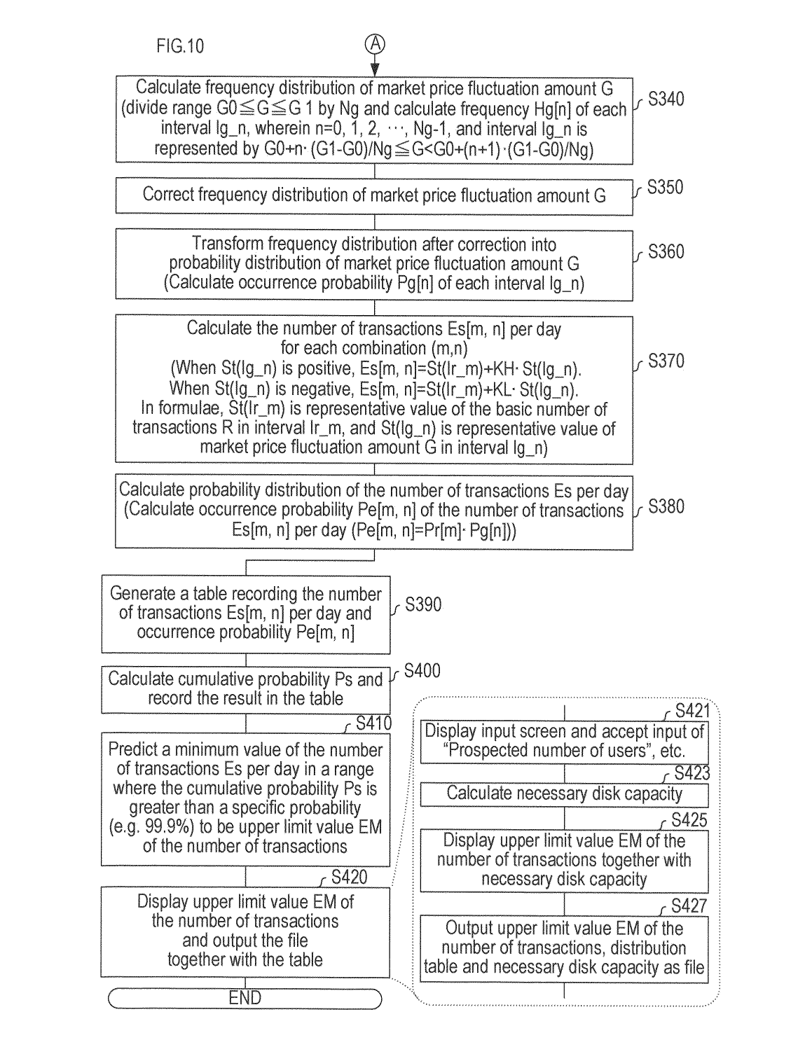

Instead of the prediction processing shown in FIG. 3A and FIG. 3B, the prediction apparatus 1 according to the second embodiment is configured such that the operation device 10 executes the prediction processing shown in FIGS. 9 and 10. The other configuration is the same as in the first embodiment. Therefore, the content of the prediction processing shown in FIGS. 9 and 10 is selectively described below. Also, explanation about the structure of the prediction apparatus 1 according to the second embodiment, that is the same as in the first embodiment, is appropriately omitted. Furthermore, in the prediction processing of the second embodiment shown in FIGS. 9 and 10, the step, to which the same step number as that of the prediction processing shown in FIG. 3A and FIG. 3B is assigned, executes the processing having the same contents as in the first embodiment. In describing the prediction processing according to the second embodiment, explanation about the step executing the processing, which content is the same as in the first embodiment, is appropriately omitted.

When the prediction processing shown in FIGS. 9 and 10 is started, the operation device 10 executes, similarly to the first embodiment, the processing of S110 to S180. Accordingly, the basic fluctuation amount KH during market price appreciation and the basic fluctuation amount KL during market price depreciation are calculated. At the same time, the basic number of transactions R for each day, for which a record is recorded in the transaction performance data, is calculated. Then, if the determination at S180 is Yes, the processing proceeds to S310.

When the processing proceeds to S310, the operation device 10 calculates a frequency distribution of the basic number of transactions R in a sample period. The “sample period” as described herein refers to aggregation of the transaction days for which a record is recorded in the transaction performance data.

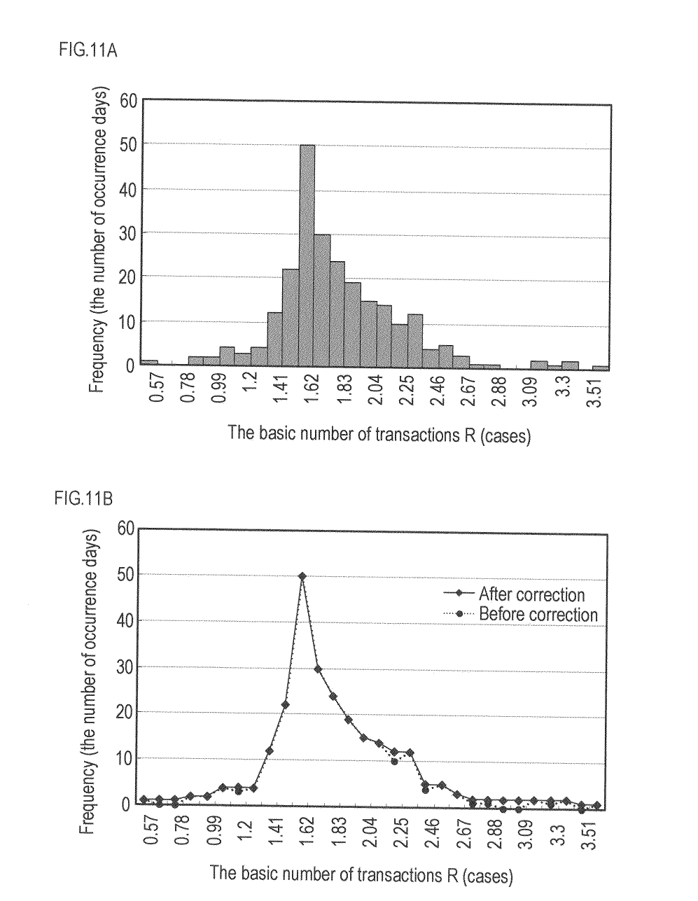

In S310, the range R0≦R≦R1 of the basic number of transactions R, in which a frequency distribution is specifically calculated, is divided by a predetermined division number Nr. Then, as shown in FIG. 11, a frequency Hr[m] of the basic number of transactions R corresponding to each divided interval Ir_m (wherein, m=0, 1, 2, . . . , Nr−1) is calculated. The frequency Hr[m] is the number of samples whose basic number of transactions R falls within an interval Ir_m. In other words, the frequency Hr[m] corresponds to the number of occurrence days on which the basic number of transactions R is included in an interval Ir_m.

R0 can be set to be a minimum value of the basic number of transactions R (that is, a minimum value of the basic number of transactions R calculated by the processing of S110 to S180) in the sample period. Also, R1 can be set to be a maximum value of the basic number of transactions R in the sample period. Also, the interval Ir_m represents an interval R0+m·(R1−R0)/Nr≦R≦R0+(m+1)·(R1−R0)/Nr. However, only the interval Ir_(Nr−1) is defined by the interval R0+(Nr−1)·(R1−R0)/Nr≦R≦R1. In FIG. 11A, (an example of) the frequency distribution of the basic number of transactions R calculated in S310 is shown.

After the processing of S310, the frequency distribution of the basic number of transactions R calculated in S310 is corrected so as to show unimodality (S320).

Specifically, the interval Ir_m having the highest frequency Hr[m] is identified. Then, the interval Ir_m having the highest frequency Hr[m] is defined as a boundary. Subsequently, the frequency distribution is corrected so that the frequency Hr[m] of each interval Ir_m, which has the larger basic number of transactions R than the boundary interval, is monotonically non-increasing. Furthermore, the frequency distribution is corrected so that the frequency Hr[m] of each interval Ir_m, which has the smaller basic number of transactions R than the boundary interval, is monotonically non-decreasing.

FIG. 11B is a line graph showing the frequency distribution of the basic number of transactions R. In the line graph, the frequency distribution before correction is indicated with a dotted line, and the frequency distribution after correction is indicated with a solid line.

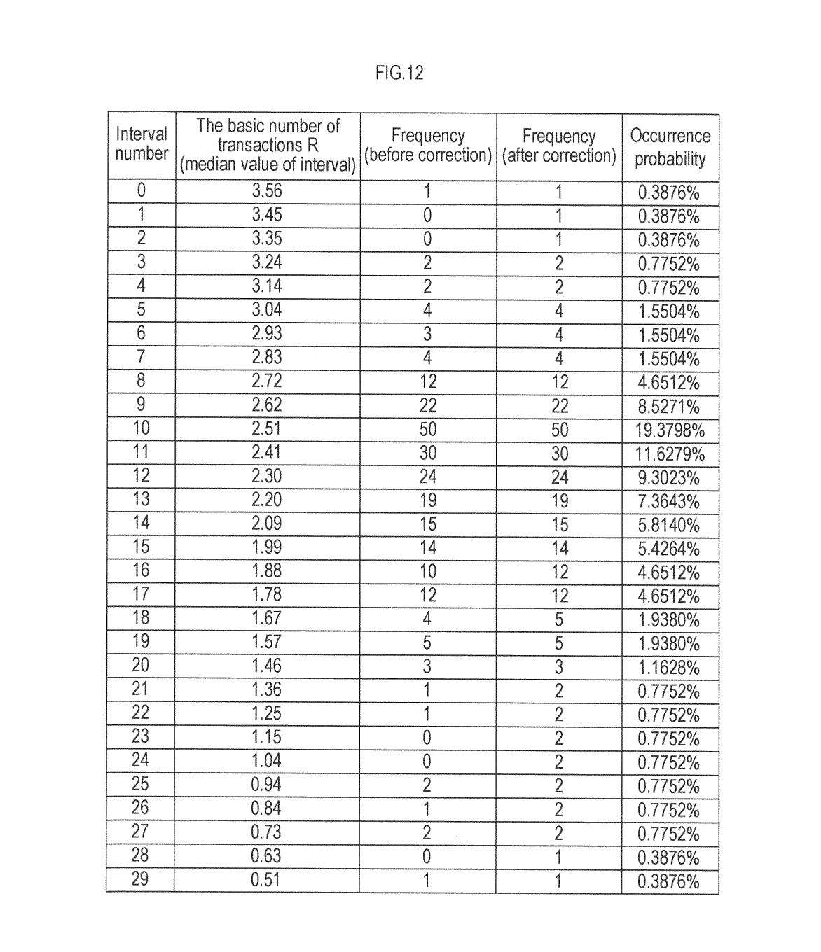

In addition, FIG. 12 shows the data corresponding to the line graph shown in FIG. 11B. The table shows the frequency Hr[m] before correction and the frequency Hr′[m] after correction for each interval Ir_m. Hereinafter, with respect to the frequency Hr[m] of the basic number of transactions R, the frequency after correction is expressed as Hr′[m]. Additionally, the interval Ir_m having the highest frequency Hr[m] in the data shown in FIG. 12 is the interval m=10, which shows the frequency Hr[m]=50. In this data, the division number is Nr=30.

The correction method in S320 is detailed below. In S320, the frequency Hr[m] for each interval Ir_m is referred to successively from the boundary interval as a starting point in the direction in which the basic number of transactions R increases. Then, if a local peak (a local maximum point) of the frequency Hr[m] is detected, the frequency Hr[m] for each interval having the frequency Hr[m] lower than the local peak is corrected to the frequency Hr[m] of the local peak as shown in FIG. 11B. In this case, the interval to be corrected is located prior to the local peak (that is, the interval having the basic number of transactions R smaller than that corresponding to the local peak, on the premise that the interval has the basic number of transactions R larger than that corresponding to the starting point).

Also, the frequency Hr[m] for each interval Ir_m is referred to successively from the boundary interval as a starting point in the direction in which the basic number of transactions R decreases. Then, if a local peak (a local maximum point) of the frequency Hr[m] is detected, the frequency Hr[m] for each interval having the frequency Hr[m] lower than the local peak is corrected to the frequency Hr[m] of the local peak as shown in FIG. 11B. In this case, the interval to be corrected is located prior to the local peak (that is, the interval having the basic number of transactions R larger than that corresponding to the local peak, on the premise that the interval has the basic number of transactions R smaller than that corresponding to the starting point). Thus, a local peak is removed, and the frequency distribution is corrected so as to include a single peak.

When this processing is completed, the operation device 10 transforms the frequency distribution after correction into a probability distribution of the basic number of transactions R (S330).

Specifically, an occurrence probability Pr[m] of the basic number of transactions R corresponding to each interval Ir_m (m=0, 1, 2 . . . , Nr−1) is calculated by the following formula:

Pr[m]=Hr′[m]/Σr

wherein Σr is a total amount of the frequencies Hr′[m] for all intervals.

FIG. 12 shows the occurrence probability Pr[m] of the basic number of transactions R corresponding to each interval, as well as the frequencies Hr[m] and Hr′[m] corresponding to each interval.

After the probability distribution of the basic number of transactions R is calculated by making a correction to show unimodality as described above, a frequency distribution of the market price fluctuation amount G is calculated according to the idea similar to in S310 (S340). Then, the calculated frequency distribution is corrected to show unimodality according to the idea similar to in S320 (S350). The corrected frequency distribution is transformed into a probability distribution of the market price fluctuation amount G (S360).

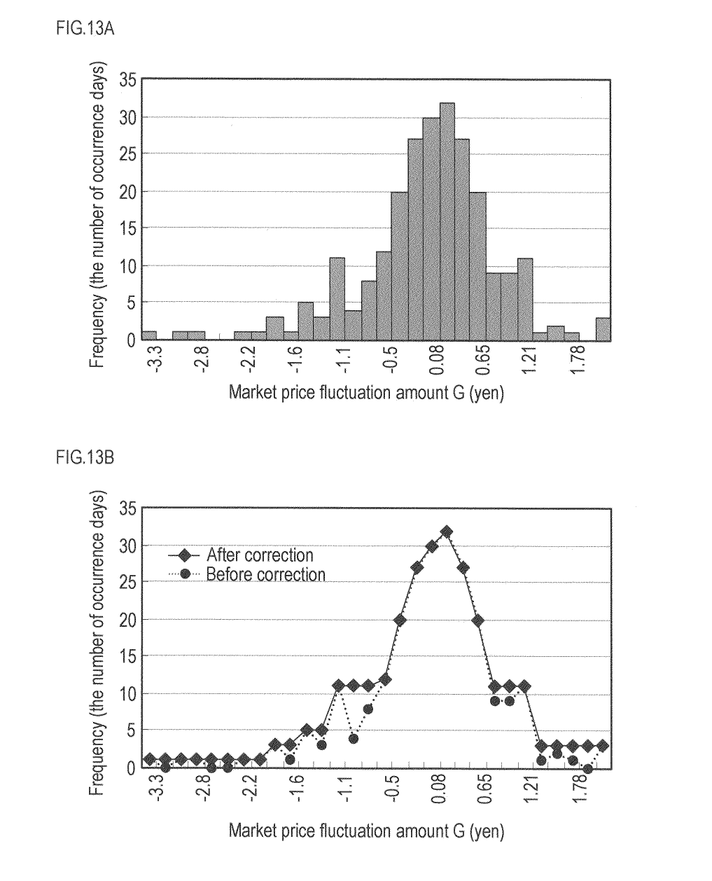

That is, in S340, the range G0≦G≦G1 of the market price fluctuation amount G, for which the frequency distribution is calculated, is divided by a predetermined division number Ng. Then, as shown in FIG. 13, a frequency Hg[n] of the market price fluctuation amount G corresponding to each divided interval Ig_n (wherein, n=0, 1, 2, . . . , Ng−1) is calculated. The frequency Hg[n] is the number of samples whose market price fluctuation amount G is included in the interval Ig_n, and corresponds to the number of occurrence days on which the market price fluctuation amount G is included in the interval Ig_n.

G0 can be set to be a minimum value of the market price fluctuation amount G in the sample period. Also, G1 can be set to be a maximum value of the market price fluctuation amount G in the sample period. Also, the interval Ig_n means an interval G0+n·(G1−G0)/Ng≦G<G0+(n+1)·(G1−G0/Ng. However, the interval Ig_(Ng−1) located at the end, as an only exception, is defined by an interval of G0+(Ng−1)·(G1−G0)/Ng≦G≦G1. In FIG. 13A, an example of the frequency distribution of the market price fluctuation amount G calculated in S340 is shown.

After the processing of S340, the frequency distribution of the market price fluctuation amount G is corrected (S350). Specifically, the interval Ig_n having the highest frequency Hg[n] is defined as a boundary. Then, the frequency distribution is corrected so that the frequency Hg[n] of each interval Ig_n, which has the larger market price fluctuation amount G than the boundary interval, is monotonically non-increasing. Furthermore, the frequency distribution is corrected so that the frequency Hg[n] of each interval Ig_n, which has the smaller market price fluctuation amount G than the boundary interval, is monotonically non-decreasing.

FIG. 13B is a line graph showing the frequency distribution of the market price fluctuation amount G. In the line graph, the frequency distribution before correction is indicated with a dotted line, and the frequency distribution after correction is indicated with a solid line.

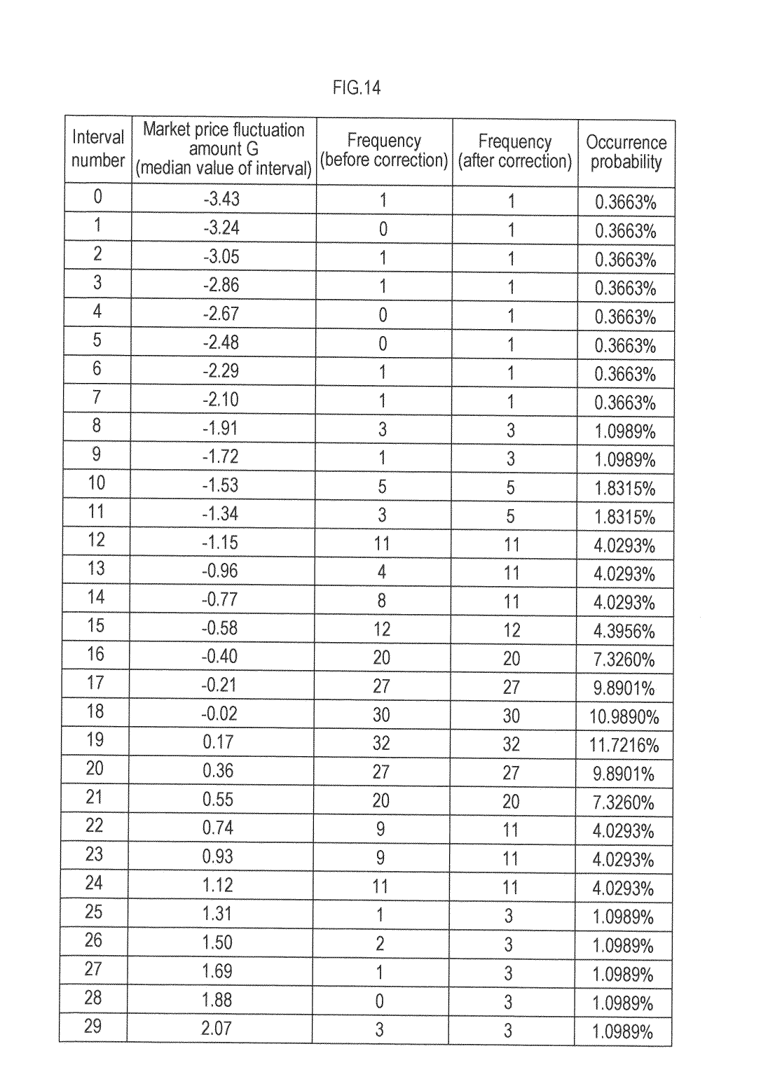

In addition, FIG. 14 shows the data corresponding to the line graph shown in FIG. 13B. The table shows the frequency Hr[n] before correction and the frequency Hr′[n] after correction for each interval Ir_n. Hereinafter, with respect to the frequency Hr[n] of the market price fluctuation amount G, the frequency after correction is expressed as Hr′[n]. Additionally, the interval Ig_n having the highest frequency Hg[n] in the data shown in FIG. 14 is the interval of n=19 representing the frequency Hr[n]=32. In this data, the division number is Ng=30.

After the above processing is completed, the frequency distribution obtained by making a correction to show unimodality is transformed into a probability distribution of the market price fluctuation amount G (S360).

Specifically, an occurrence probability Pg[n] of the market price fluctuation amount G corresponding to each interval Ig_n (n=0, 1, 2, . . . , Ng−1) is calculated by the following formula:

Pg[n]=Hg′[n]/Σg

wherein Σg is a total amount of the frequencies Hg′[n] for all intervals.

FIG. 14 shows the occurrence probability Pg[n] of the market price fluctuation amount G corresponding to each interval, as well as the frequencies Hg[n] and Hg′[n] corresponding to each interval.

After the probability distribution of the market price fluctuation amount G obtained by making a correction to show unimodality is calculated as described above, the number of transactions Es[m, n] per day for each combination of the basic number of transactions R and the market price fluctuation amount G is calculated (S370). Specifically, the number of transactions Es[m, n] per day for each combination of the interval Ir_m and the interval Ig_n is calculated, using a representative value St(Ir_m) of the basic number of transactions R in the interval Ir_m and a representative value St(Ig_n) of the market price fluctuation amount G in the interval Ig_n. The representative value St(Ir_m) can be determined, for example, to be a median value (R0+(m+½)·(R1−R0)/Nr) of the interval Ir_m, and the representative value St(Ig_n) can be determined, for example, to be a median value (G0+(n+½)(G1−G0)/Ng) of the interval Ig_n.

When the representative value St(Ig_n) of the market price fluctuation amount G is positive, the number of transactions Es[m, n] per day is calculated by the following formula:

Es[m,n]=St(Ir_{—}m)+KH·St(Ig_{—}n)

wherein KH is the basic fluctuation amount during market price appreciation as described above.

Also, the number of transactions Es[m, n] per day as described herein strictly means the number of transactions per day per user.

On the other hand, when the representative value St(Ig_n) of the market price fluctuation amount G is negative, the number of transactions Es[m, n] per day is calculated by the following formula:

Es[m,n]=St(Ir_{—}m)+KL·St(Ig_{—}n)

wherein KL is the basic fluctuation amount during market price depreciation as described above.

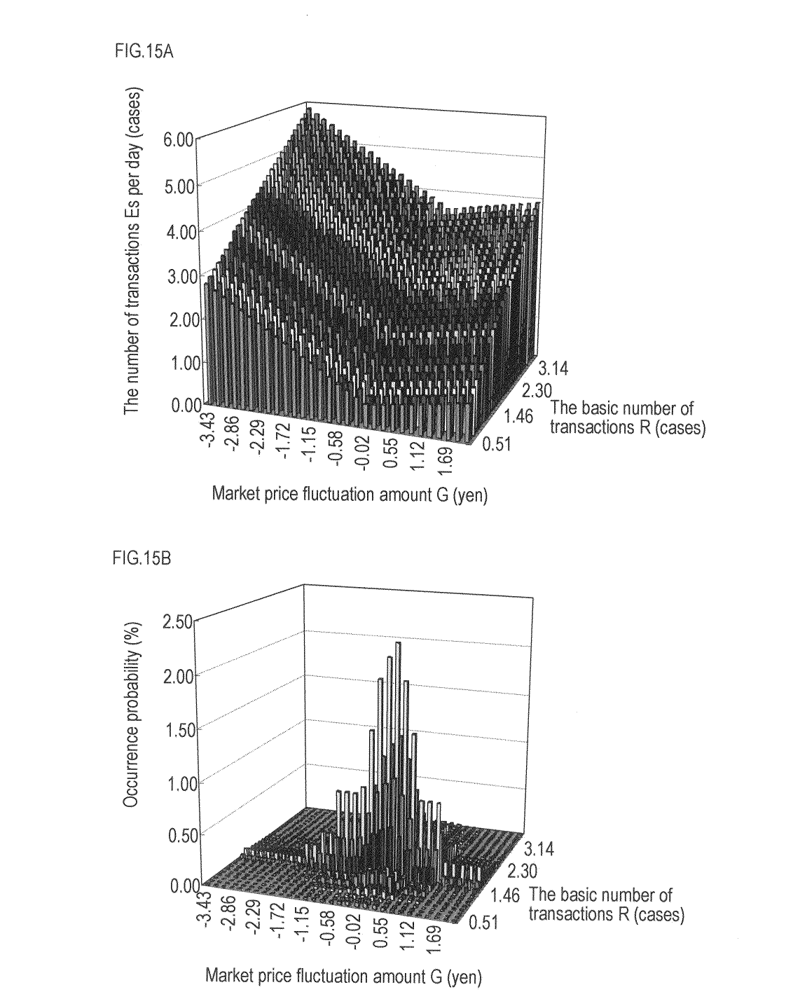

FIG. 15A is a bar chart showing the number of transactions Es[m, n] per day for each combination of the interval Ir_m and the interval Ig_n.

After the processing of S370, the probability distribution of the number of transactions Es[m, n] per day is calculated (S380).

Specifically, for each combination (m, n) of m=0, 1, . . . , Nr−1 and n=0, 1, . . . , Ng−1, an occurrence probability Pe[m, n] corresponding to the number of transactions Es[m, n] per day is calculated by the following formula:

Pe[m,n]=Pr[m]·Pg[n]

wherein as described above, Pr[m] is the occurrence probability of the basic number of transactions R included in the interval Ir_m, and the Pg[n] is the occurrence probability of the market price fluctuation amount G included in the interval Ig_n.

FIG. 15B is a bar chart showing the probability distribution of the number of transactions Es[m, n] per day.

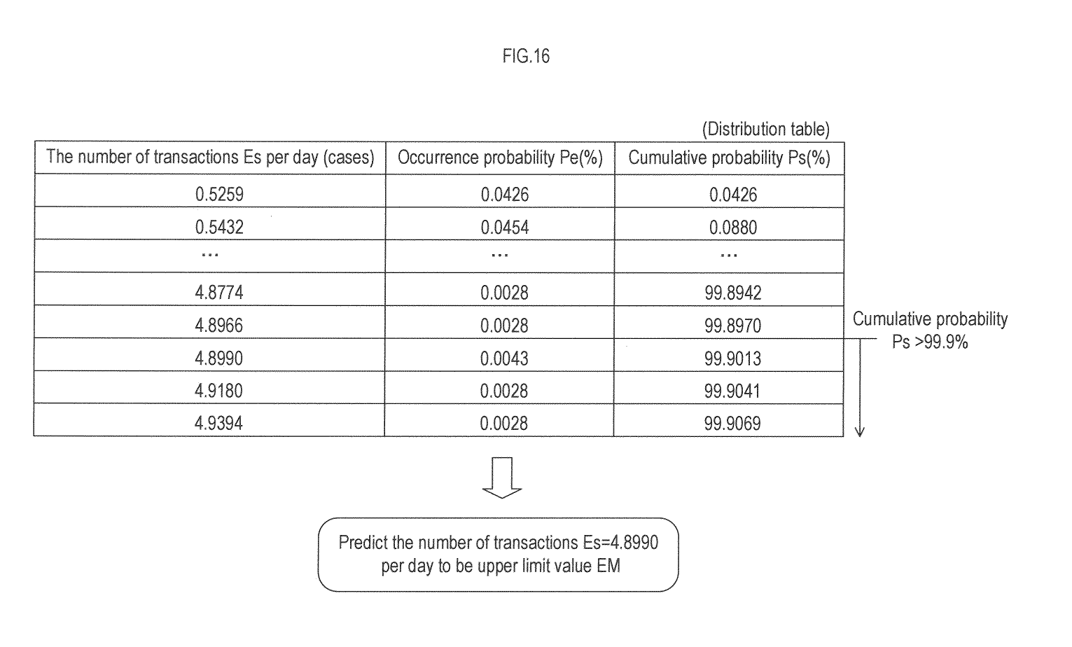

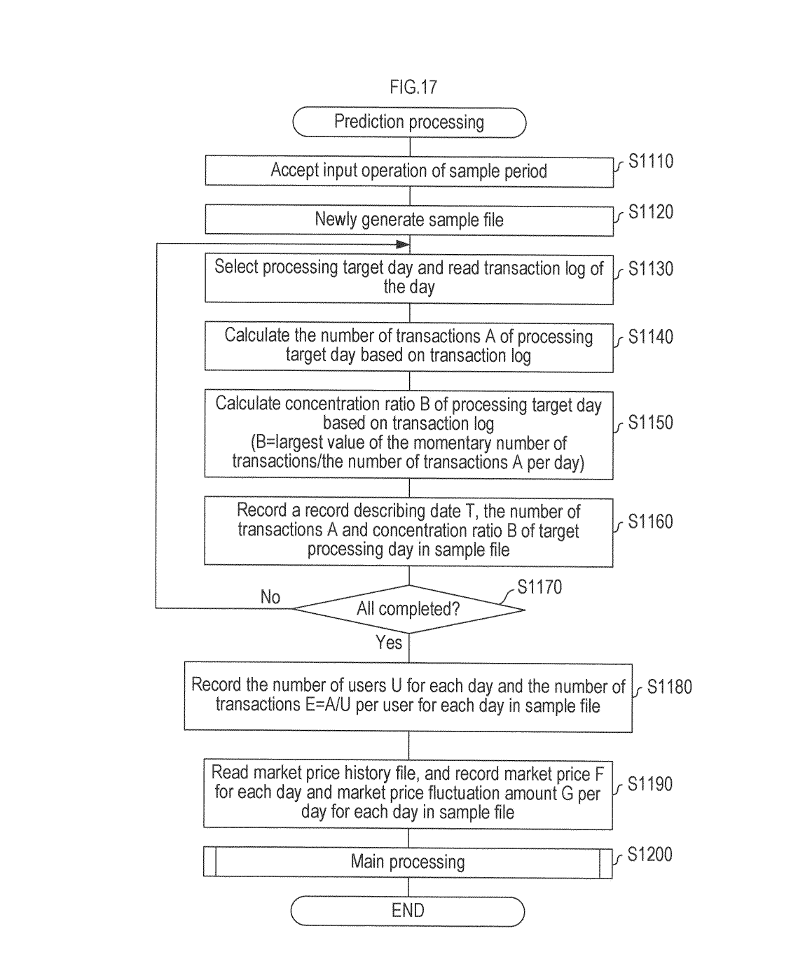

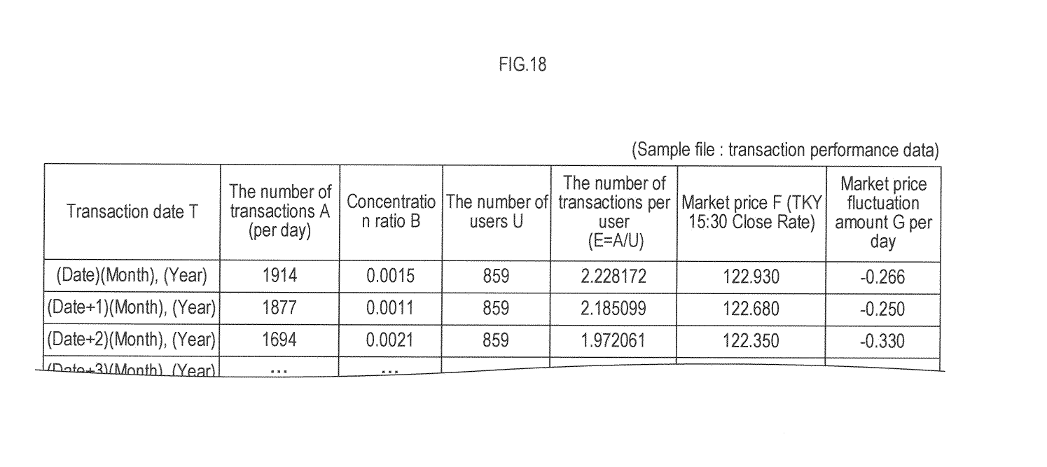

After the processing of S380, the operation device 10 generates a table (hereinafter, expressed as a “distribution table”) regarding the probability distribution of the number of transactions Es[m, n] per day (S390). In the distribution table, a record, in which the number of transactions Es[m, n] per day, the occurrence probability Pe[m, n] and the cumulative probability Ps[m, n] are related to each other, is recorded for the each combination (m, n). However, a field of the cumulative probability Ps[m, n] should be empty when the table is generated. In this distribution table, the above record corresponding to each combination (m, n) is recorded so as to be positioned (sorted) in ascending order of the number of transactions Es[m, n] per day. FIG. 16 shows an example of the structure of the distribution table.

Also, when the distribution table is prepared, the operation device 10 records the cumulative probability Ps[m, n] in each record in the distribution table (S400). Here, the cumulative probability Ps[m, n] recorded in each record is a total amount of the “occurrence probability Pe[m, n] of the record in which the cumulative probability Ps[m, n] is to be recorded” and “each occurrence probability Pe[m, n] represented by a group of records having the smaller number of transactions Es[m, n] per day than the record to be recorded”. That is, the cumulative probability Ps[m, n] represents the probability in which the number of transactions per day per user is the value Es[m, n] or below for each day in the future.

Thereafter, the operation device 10 successively refers to a record in ascending order of the number of transactions Es[m, n] per day in the distribution table. Then, the operation device 10 identifies, as shown in FIG. 16, the number of transactions Es[m, n] per day right after the cumulative probability Ps[m, n] exceeds a specific probability (99.9% in the present embodiment). In the present embodiment, the identified value is predicted to be an upper limit EM of the number of transactions per day per user in the transaction system MS in the future (S410).

Thereafter, the operation device 10 displays the predicted upper limit EM of the number of transactions on the display device 30. At the same time, the operation device 10 generates a log file describing the upper limit EM of the number of transactions and the distribution table. Then, the generated log file is stored in the memory device (S420). Generating the log file and storing the generated log file in the memory device 20 enables an operator of the prediction apparatus 1 to check the predicted result again later, through a separate application program installed in the prediction apparatus 1. Then, the operation device 10 terminates the prediction processing.

Although the second embodiment has been described above, according to the second embodiment, the upper limit EM of the number of transactions can be calculated without using a confidence interval.

That is, the probability distribution of the number of transactions Es per day is calculated from the probability distributions of the basic number of transactions R and the market price fluctuation amount G.

Then, a minimum value of the number of transactions Es per day in a range where the cumulative probability Ps is greater than a specific probability (99.9%), is predicted to be the upper limit EM of the number of transactions. Therefore, even if the sample group does not approximate to the normal distribution, the upper limit EM of the number of transactions can be accurately calculated.

In other words, in the first embodiment, the upper limit EM of the number of transactions is calculated using a confidence interval on the premise that the sample group follows a normal distribution. Accordingly, when the sample group does not follow a normal distribution, the upper limit EM of the number of transactions cannot be accurately calculated. Therefore, when the number of samples is limited and the sample group is significantly different from the normal distribution, prediction accuracy of an upper limit EM of the number of transactions deteriorates. On the other hand, according to the second embodiment, even when the number of samples is limited and the sample group is significantly different from a normal distribution, the upper limit EM of the number of transactions can be accurately calculated.

Also, according to the present embodiment, the frequency distribution is corrected into a unimodal mound shape by the above-described method. Furthermore, the probability distributions of the basic number of transactions R and the market price fluctuation amount G are calculated based on the frequency distribution after correction. Therefore, according to the present embodiment, an upper limit EM of the number of transactions can be calculated with a high degree of accuracy while inhibiting influence by variation of samples.

However, when the number of samples is sufficient and the sample group follows a normal distribution, calculation of an upper limit EM of the number of transactions using a confidence interval is simpler as a processing procedure. Therefore, the prediction apparatus 1 may be configured to be capable of switching between the calculation of an upper limit EM of the number of transactions by executing the prediction processing according to the first embodiment and the calculation of an upper limit EM of the number of transactions by executing the prediction processing according to the second embodiment.

That is, similarly to the prediction processing according to the first and second embodiments, the processing of S110 to S180 is executed. Then, it is determined whether or not the number of samples (the number of records in the transaction performance data) is the predetermined value and above in the step after the determination in S180 is Yes. Then, if the number of samples is the predetermined value or above, similarly to the prediction processing of the first embodiment, the processing of S190 to S270 is executed. If the number of samples is smaller than the predetermined value, then the processing of S310 and thereafter is executed similarly to the prediction processing of the second embodiment. The prediction apparatus 1 can be configured as described above.

In addition, instead of determining whether or not the number of samples is the predetermined value or above, the prediction apparatus 1 may be configured to execute processing of evaluating the degree of coincidence with the normal distribution for each of the basic number of transactions R and the market price fluctuation amount G. That is, the prediction apparatus 1 may be configured to execute the processing of S190 to S270 in the same manner as the prediction processing according to the first embodiment if the degree of coincidence with the normal distribution is high, and to execute the processing of S310 and thereafter in the same manner as the prediction processing according to the second embodiment if the degree of coincidence with the normal distribution is low.

Also in the second embodiment, similarly to the first embodiment, resources necessary for the transaction system MS may be estimated based on the upper limit EM of the number of transactions to display the estimated result. For example, the prediction device according to the second embodiment can be configured to calculate the “necessary disk capacity” and display the calculated result on the display device 30. Furthermore, the prediction apparatus may be configured to store a log file, which describes the “necessary disk capacity” together with the upper limit EM of the number of transactions and the distribution table, in the memory device 20.

At the bottom right of FIG. 10, the detail of S420 regarding this example is shown. In this example, an input screen is displayed to accept input of the “prospected number of users” and the constants K1 and K2 through the input device 40 (S421). When the “prospected number of users” and the constants K1 and K2 are inputted through the input device 40, the necessary disk capacity is calculated by the above-described formula:

“Necessary disk capacity”=K1×EM×“Prospected number of users”+K2 (S423)

Thereafter, the upper limit EM of the number of transactions predicted in S410 is displayed on the display device 30 together with the necessary disk capacity calculated in S423 (S425). Furthermore, the log file, which describes the upper limit EM of the number of transactions, the distribution table and the necessary disk capacity, is stored in the memory device 20 (S427). The prediction apparatus 1 can be configured in this manner.

The correspondence relation between the terms regarding the prediction apparatus 1 of the second embodiment is described below. The function realized by the processing of S310 to S420 corresponds to an example of the function realized by the prediction device (procedure). Also, the function realized by the processing of S310 to S330 corresponds to an example of the function realized by the transactions distribution calculation device (procedure), and the function realized by the proceeding of S340 to 5360 corresponds to an example of the function realized by the fluctuation amount distribution calculation device (procedure).

### Third Embodiment

Next, a prediction apparatus 1 according to the third embodiment will be described. The prediction apparatus 1 according to the present embodiment predicts an upper limit of the number of transactions per short time period (the momentary number of transactions) to provide information for adequately adjusting resources of the transaction system MS (see FIG. 2). Specifically, the prediction apparatus 1 according to the present embodiment predicts an upper limit of the momentary number of transactions per user. A system operator of the transaction system MS, for example, mounts CPUs, which have the processing capability corresponding to the prospected number of users, in the transaction system MS based on the predicted result. Accordingly, a stable operation of the transaction system MS at low cost while inhibiting an excess investment in the transaction system MS is realized.

For ease of discussion, in the prediction apparatus 1 described below, similarly to the first and second embodiments, it is assumed that the transaction system MS is a transaction system specializing in a dollar-yen foreign exchange transaction. With respect to a resource adjustment of the transaction system capable of executing more than one type of foreign exchange transaction dealing with different currencies, an upper limit of the momentary number of transactions may be predicted for each type of transaction by the procedure similar to the prediction method discussed below. Then, resources of the transaction system may be adjusted based on the combined value of an upper limit of the momentary number of transactions for each type.

The prediction apparatus 1 according to the present embodiment predicts an upper limit Qz of the momentary number of transactions for a dollar-yen foreign exchange transaction in the transaction system MS, by executing the prediction processing shown in FIG. 17, in accordance with an instruction inputted from the input device 40. Then, based on the predicted result, the operation capacity (the necessary number of CPUs) necessary for the transaction system MS is calculated. The prediction processing is realized by the fact that the operation device 10 executes a dedicated program stored in the memory device 20 in a CPU 11.

When the prediction processing is started, the operation device 10 accepts information specifying the sample period, which is inputted through the input device 40 by an operator of the prediction apparatus 1 (S1110). When the upper limit Qz of the momentary number of transactions is predicted, samples regarding the past transaction are required. Here, the information specifying the sample period, that is, a period in which the transaction performance is used as a sample, is accepted through the input device 40.

When the above processing is completed, the operation device 10 newly generates a sample file in the memory device 20. The sample file is a data file in which the transaction performance data in the sample period is stored (S1120).

Then, a processing target day is selected from a group of days corresponding to the sample period. The processing of S1130 and thereafter is executed with respect to the selected processing target day. Specifically, firstly, a transaction log for the processing target day is read from the memory device 20 (S1130). The transaction log is a data file representing a transaction history per day. In this data file, a group of records representing the executed time and content for each transaction performed on the day is stored. The transaction log for each day is recorded in the memory device 20 from outside through the external I/O device 50.

The operation device 10 calculates, based on the read transaction log, the number of transactions A for the processing target day and the concentration ratio B for the processing target day (S1140 and S1150). The concentration ratio B for the processing target day as described herein refers to a ratio B=Q/A of the momentary number of transactions Q at the time when the momentary number of transactions is largest on the processing target day to the total number of transactions (the number of transactions A) on the processing target day. In the present embodiment, 30 seconds is defined as a short time period, and the number of transactions per 30 seconds is dealt with as the “momentary number of transactions”.

Particularly, in S1150, the interval (30 seconds) having the largest number of transactions per 30 seconds (the momentary number of transactions) is identified, based on the transaction log of the processing target day. Then, the value obtained by dividing the number of transactions (the momentary number of transactions Q) in the identified interval by the number of transactions A on the processing target day is calculated as the concentration ratio B on the processing target day. In this case, it is noted that the short time period is not necessarily limited to 30 seconds, and may be any time as long as the time is sufficiently short relative to a day.

When the number of transactions A and the concentration ratio B for the processing target day are calculated, the operation device 10 records a record, which describes a date T, the number of transactions A, and the concentration ratio B for the processing target day, in the sample file (S1160). In the present embodiment, a record for each day corresponding to the sample period as shown in FIG. 18 is recorded in the sample file. The record includes fields of the date T of the day, the number of transactions A of the day, the concentration ratio B of the day, the number of users U as of the day, the number of transactions E per user of the day, the market price (yen rate) F at a predetermined time T0 of the day, and the market price fluctuation amount G of the day.

In S1160, the record configured as above is recorded with the fields other than the date T, the number of transactions A, and the concentration ratio B of the processing target day being made empty.

The operation device 10 repeats execution of the processing of S1130 to S1160 described above, until the record for each day corresponding to the sample period is recorded in the sample file. When an action of recording the records for all the days corresponding to the sample period in the sample file is completed, the determination of Yes is made in S1170. Then, the processing proceeds to S1180.

Also, in S1180, based on the number of users file stored in the memory device 20, the number of users U of the day is recorded in the field of the number of users U of each record stored in the sample file. At the same time, the number of transactions per user E=A/U of the day, which is a value obtained by dividing the number of transactions A of the day by the number of users U of the day, is recorded in the field of the number of transactions E in each record.

The number of users U of the day refers to, as described in the first embodiment, the number of users allowed to use the transaction system MS on the day by signing the utilization contract before the day. In other words, the number of users U of the day means the number of users of the transaction system MS, who were allowed to request a transaction through the transaction system MS whether or not a transaction was actually requested on the day. The number of users file is previously prepared as a data file representing the number of users U of each day in the past, and stored in the memory device 20 through the external I/O device 50.

When the above processing is completed, based on the market price history file stored in the memory device 20, a market price F at the predetermined time T0 of the day is recorded in the field of a market price F for each record stored in the sample file (S1190). Furthermore, the market price fluctuation amount G for the day is recorded in the field of a market price fluctuation amount G in each record. In the present embodiment, similarly to the first embodiment, a value obtained by subtracting the market price F at the predetermined time T0 of a day before the day from the market price F at the predetermined time T0 of the day is recorded as a market price fluctuation amount G of the day.

In the present embodiment, the transaction performance data including a group of records in the sample period is recorded in the sample file, as described above. The numbers of transactions A and E, the market price fluctuation amount G and the concentration ratio B for each day can be identified from the recorded transaction performance data.

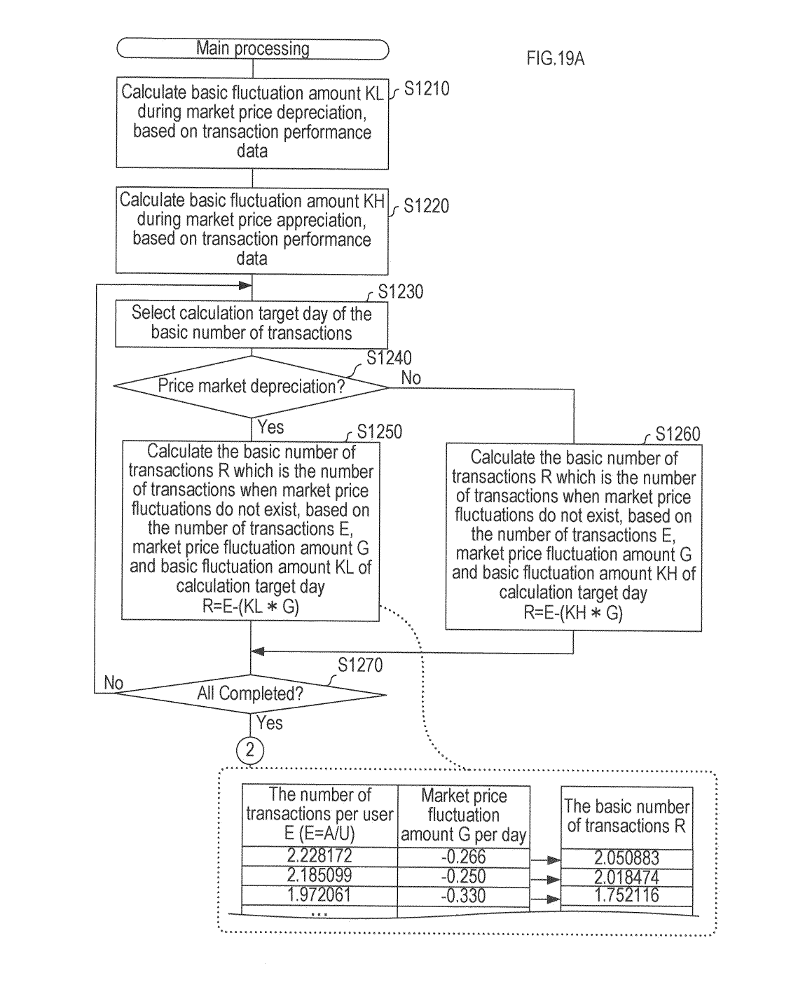

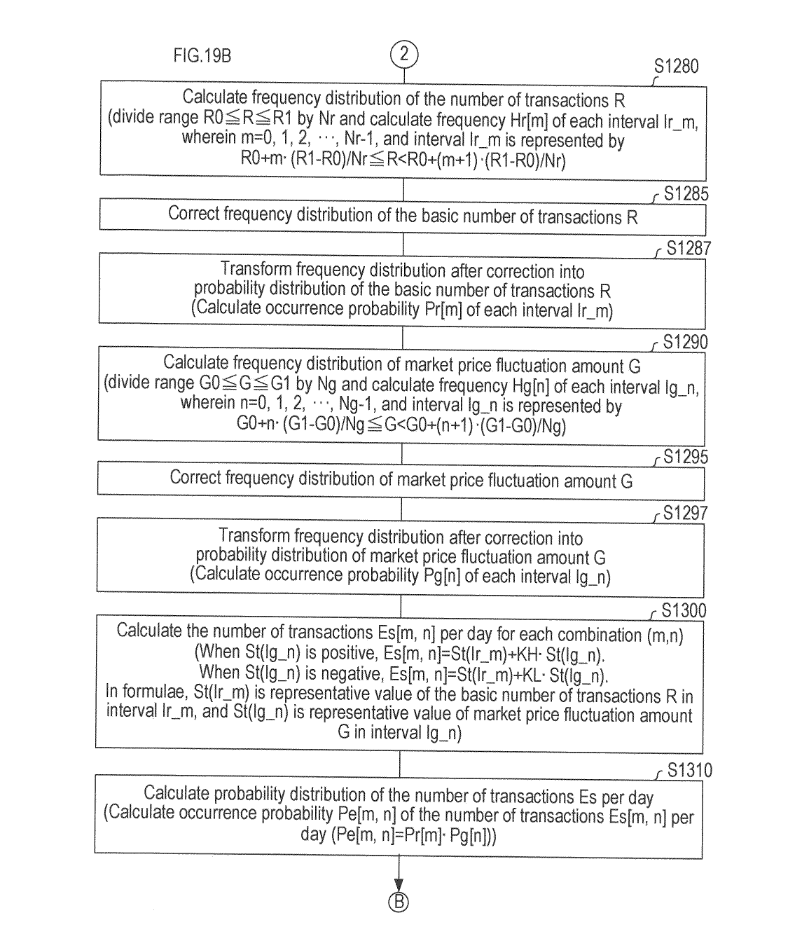

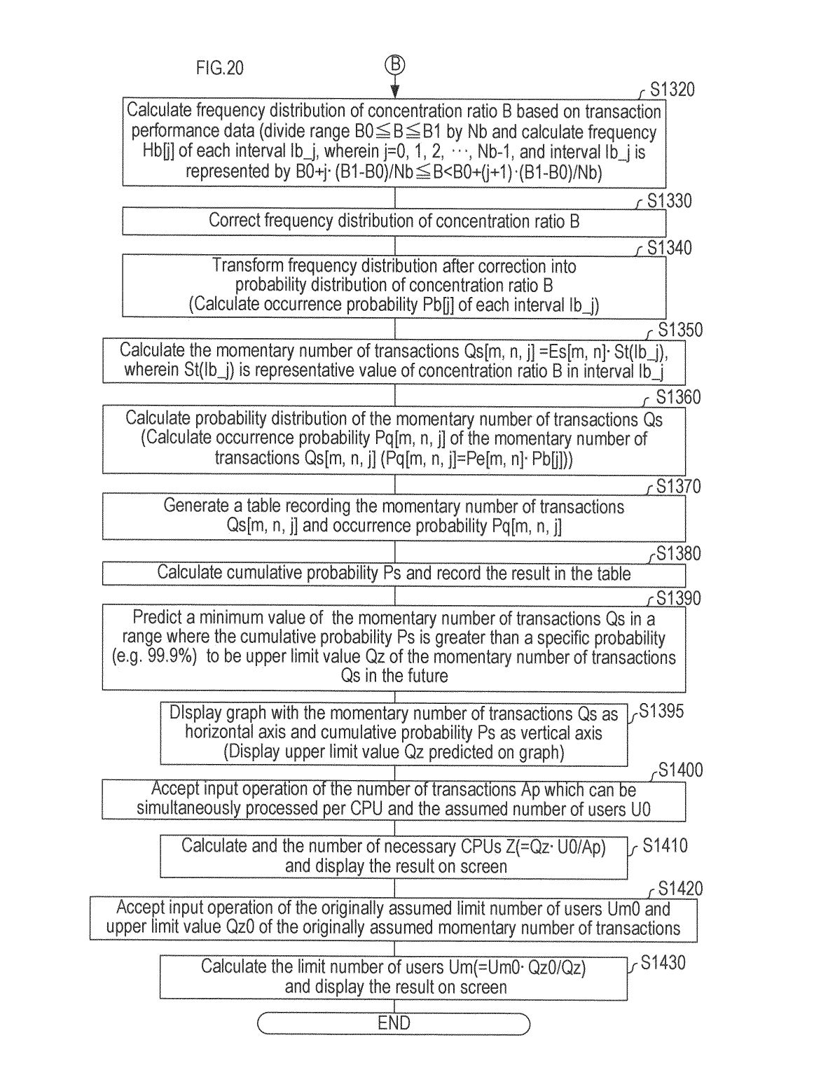

When the processing in S1190 is completed, the operation device 10 executes the main processing shown in FIGS. 19 and 20 (S1200). In the main processing, based on a group of records (the transaction performance data) stored in the sample file, similarly to the first and second embodiments, a linear regression analysis is performed to calculate the basic fluctuation amount KL during market price depreciation (dollar depreciation) and the basic fluctuation amount KH during market price appreciation (dollar appreciation) (S1210 and S1220).

When the processing in S1210 and S1220 is completed, the operation device 10 sets one of the days corresponding to the sample period as a calculation target day of the basic number of transactions R (S1230). Then it is determined whether or not the market price fluctuation amount G represented by the record of the calculation target day is negative. Thus, it is determined whether or not the calculation target day is a day of market price depreciation (S1240).

If the calculation target day is a day of market price depreciation (Yes in S1240), the processing proceeds to S1250. In S1250, the basic number of transactions R of the calculation target day is calculated by substituting the number of transactions E and the market price fluctuation amount G represented by the record of the calculation target day, and the basic fluctuation amount KL during market price depreciation calculated in S1210, for the following formula:

R=E−KL·G

Thereafter, the processing proceeds to S1270.

On the other hand, when it is determined that the market price fluctuation amount G represented by the record of the calculation target day is positive or zero, and the corresponding day is a day during market price appreciation (No in S1240), the processing proceeds to S1260. In S1260, the basic number of transactions R of the calculation target day is calculated by substituting the number of transactions E and the market price fluctuation amount G represented by the record of the calculation target day, and the basic fluctuation amount KH during market price appreciation calculated in S1220, for the following formula:

R=E−KH·G

Thereafter, the processing proceeds to S1270.

In S1270, the operation device 10 determines whether or not the calculation of the basic number of transactions R has been completed on all the days corresponding to the sample period. If not, the processing proceeds to S1230. In S1230, a day which is not yet set as a calculation target day is newly set as a calculation target day, and the processing of S1240 and thereafter is executed.

The operation device 10 repeats the above processing to calculate the basic number of transactions R for each day corresponding to the sample period (Yes in S1270). Then, the processing proceeds to S1280.

In S1280, the operation device 10 calculates a frequency distribution of the basic number of transactions R in the sample period. In S1280, similarly to the processing in S310 of the second embodiment, the range R0≦R≦R1 of the basic number of transactions R is divided by a predetermined division number Nr. Then, as shown in FIG. 11, the frequency Hr[m] of the basic number of transactions R corresponding to each divided interval Ir_m (wherein, m=0, 1, 2, . . . , Nr−1) is calculated.

R0 can be set to be a minimum value of the basic number of transactions R in the sample period, and R1 can be set to be a maximum value of the basic number of transactions R in the sample period.

As another example, in a case where the probability distribution of the basic number of transactions R is presumed to a normal distribution, a mean pr and a standard deviation or of the basic number of transactions R in the sample period may be calculated to define the range R0≦R≦R1 of the basic number of transactions R to be the range μr−5σr≦R≦μr+5σr (R0=μr−5σr, R1=μr+5σr) in which an occurrence probability is generally 100%. However, since the basic number of transactions R cannot be a negative value, R0=0 is defined in the case of μr−5σr<0.

After the processing of S1280, the operation device 10 proceeds to S1285. In S1285, the frequency distribution of the basic number of transactions R is corrected so as to show unimodality (see FIG. 11B). That is, similarly to the second embodiment, the interval Ir_m having the highest frequency Hr[m] is identified. Then, the interval Ir_m having the highest frequency Hr[m] is defined as a boundary. Subsequently, the frequency distribution is corrected so that the frequency Hr[m] of each interval Ir_m, which has the larger basic number of transactions R than the boundary interval, is monotonically non-increasing. Furthermore, the frequency distribution is corrected so that the frequency Hr[m] of each interval Ir_m, which has the smaller basic number of transactions R than the boundary interval, is monotonically non-decreasing. Hereinafter, with respect to the frequency Hr[m] of the basic number of transactions R, the frequency after correction is expressed as Hr′[m].

When the above processing is completed, the operation device 10 transforms the frequency distribution after correction into a probability distribution of the basic number of transactions R (S1287). Specifically, an occurrence probability Pr[m] of the basic number of transactions R corresponding to each interval Ir_m (m=0, 1, 2, . . . , Nr−1) is calculated by the following formula:

Pr[m]=Hr′[m]/Σr

wherein Σr represents a total amount of the frequencies Hr′[m] after correction for each interval.

After the probability distribution of the basic number of transactions R obtained by making a correction to show unimodality is calculated as described above, the frequency distribution of the market price fluctuation amount G is calculated in the same method as the processing in S340 to 5360 of the second embodiment (S1290). Then, the frequency distribution is corrected to show unimodality (S1295). Thereafter, the frequency distribution after correction is transformed into the probability distribution of the market price fluctuation amount G (S1297).

That is, in S1290, the range G0≦G≦G1 of the market price fluctuation amount G, for which the frequency distribution is calculated, is divided by a predetermined division number Ng. Then, the frequency Hg[n] of the market price fluctuation amount G corresponding to each divided interval Ig_n (wherein, n=0, 1, 2, . . . , Ng−1) is calculated.

G0 can be set to be a minimum value of the market price fluctuation amount G in the sample period. Also, G1 can be set to be a maximum value of the market price fluctuation amount G in the sample period.

As another example, in a case where the market price fluctuation amount G is presumed to a normal distribution, the range G0≦G≦G1 of the market price fluctuation amount G, within which the probability distribution is calculated, can be defined to be μg−5σg≦G≦μg+5σg (G0=μg−5σg, G1=μg+5σg). In the inequality, μg is a mean of the market price fluctuation amount G in the sample period, and σg is a standard deviation of the market price fluctuation amount G in the sample period.

After the processing of S1290, the frequency distribution of the market price fluctuation amount G is corrected so as to show unimodality (S1295). Specifically, the interval Ig_n having the highest frequency Hg[n] is defined as a boundary. Then, the frequency distribution is corrected so that the frequency Hg[n] of each interval Ig_n, which has the larger market price fluctuation amount than the boundary interval, is monotonically non-increasing. Furthermore, the frequency distribution is corrected so that the frequency Hg[n] of each interval Ig_n, which has the smaller market price fluctuation amount G than the boundary interval, is monotonically non-decreasing. Hereinafter, with respect to the frequency Hg[n] of the market price fluctuation amount G, the frequency after correction is expressed as Hg′[n].

When the above processing is completed, the frequency distribution after correction is transformed into the probability distribution of the market price fluctuation amount G (S360). Specifically, an occurrence probability Pg[n] of the market price fluctuation amount G corresponding to each interval Ig_n (n=0, 1, 2, . . . , Ng−1) is calculated by the following formula:

Pg[n]=Hg′[n]/Σg

wherein Σg represents a total amount of the frequencies Hg′[n] after correction of all intervals.

After the probability distribution of the market price fluctuation amounts G as described above is calculated, the processing proceeds to S1300. In S1300, similarly to the processing in S370 of the second embodiment, the number of transactions Es[m, n] per day is calculated for each combination of the basic number of transactions R and the market price fluctuation amount G. Specifically, using a representative value St(Ir_m) of the basic number of transactions R in the interval Ir_m and a representative value St(Ig_n) in the interval Ig_n, the number of transactions Es[m, n] per day for each combination of the interval Ir_m and the interval Ig_n is calculated. That is, when the representative value St(Ig_n) of the market price fluctuation amount G is positive, the number of transactions Es[m, n] per day is calculated by the following formula:

Es[m,n]=St(Ir_{—}m)+KH·St(Ig_{—}n)

On the other hand, when the representative value St(Ig_n) of the market price fluctuation amount G is negative, the number of transactions Es[m, n] per day is calculated by the following formula:

Es[m,n]=St(Ir_{—}m)+KL·St(Ig_{—}n)

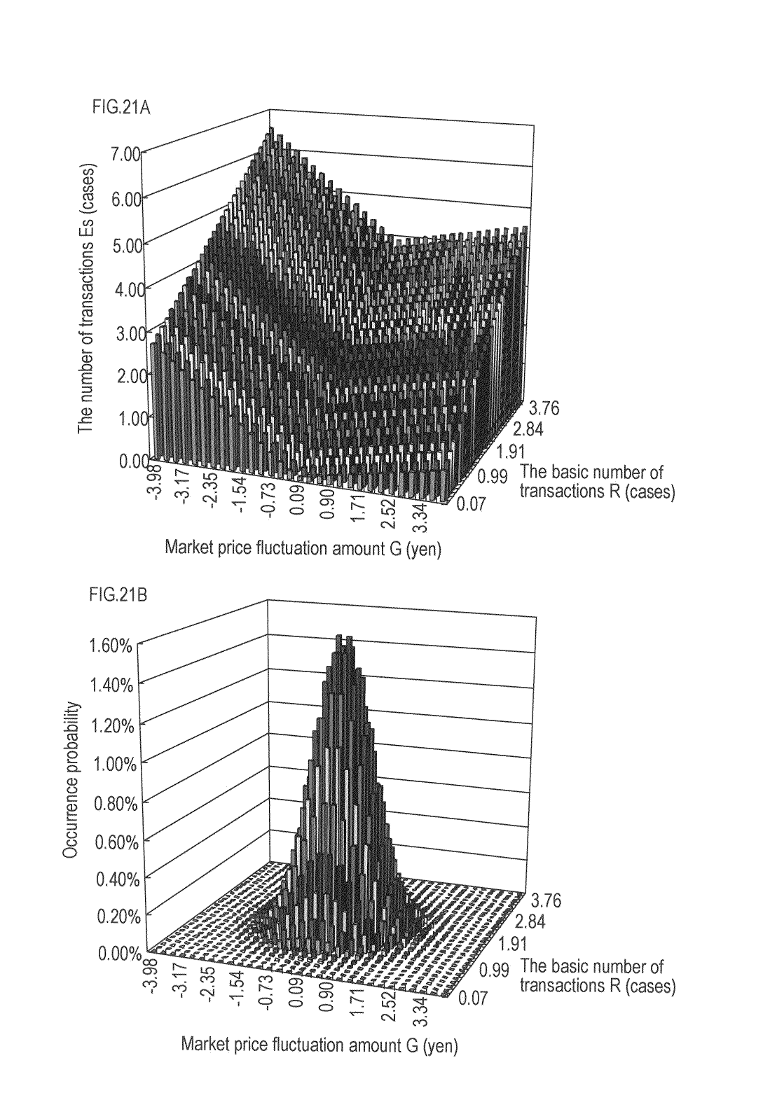

FIG. 21A is a bar chart showing the number of transactions Es[m, n] per day for each combination of the interval Ir_m and the interval Ig_n.

After the processing described above, a probability distribution of the number of transactions Es[m, n] per day is calculated (S1310). Specifically, for each combination (m, n) of m=0, 1, . . . , Nr−1 and n=0, 1, . . . , Ng−1, an occurrence probability Pe[m, n] corresponding to the number of transactions Es[m, n] per day is calculated by the following formula:

Pe[m,n]=Pr[m]·Pg[n]

As described above, Pr[m] is the occurrence probability of the basic number of transactions R included in the interval Ir_m. Also, Pg[n] is the occurrence probability of the market price fluctuation amount G included in the interval Ig_n. Also, FIG. 21B is a bar chart showing the probability distribution of the number of transactions Es[m, n] per day.

After execution of the processing of S1310, based on the transaction performance data, a frequency distribution of the concentration ratio B in the sample period is calculated (S1320).

Specifically, the range B0≦B≦B1 of the concentration ratio B, for which the frequency distribution is calculated, is divided by a predetermined division number Nb. Then, a frequency Hb[j] of the concentration ratio B is calculated for each divided interval Ib_j (wherein, j=0, 1, 2, . . . , Nb−1).

The interval Ib_j as described herein refers to an interval B0+j·(B1−B0)/Nb≦B≦B0+(j+1)·(B1−B0)/Nb. In the formula, only the interval Ib_(Nb−1) at the end is defined by the interval B0+(Nb−1)·(B1·B0)/Nb≦B≦B1.

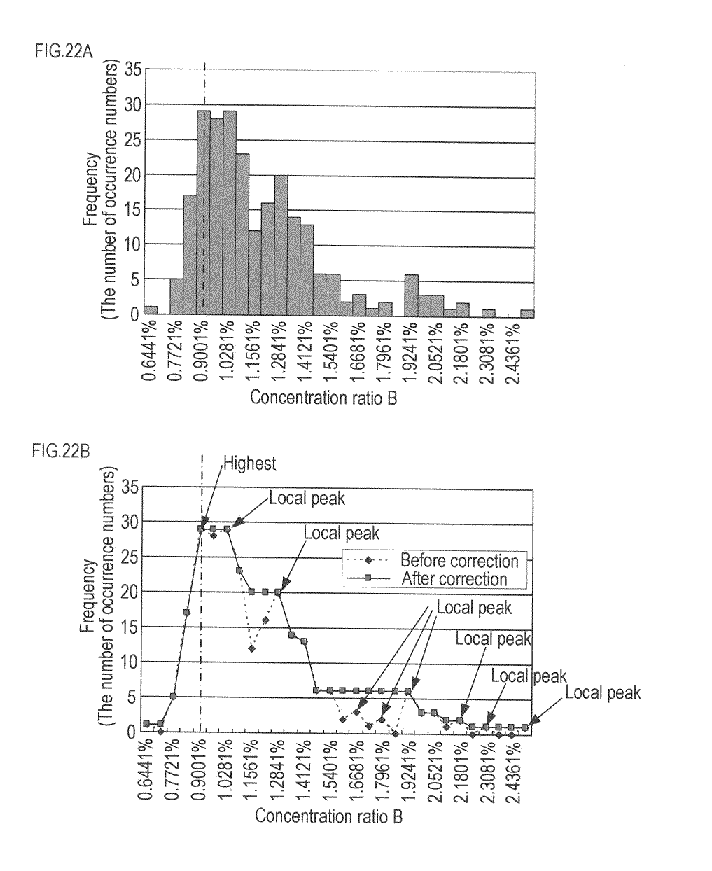

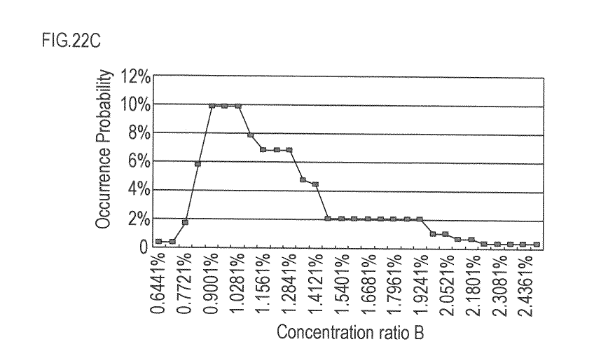

B0 can be defined by using a minimum value of the concentration ratio B in the sample period as a reference. Also, B1 can be defined by using a maximum value of the concentration ratio B in the sample period as a reference. Also, the division number Nb can be set to be, for example, Nb=30. Of course, the frequency Hb[j] is the number of samples representing the concentration ratio B included in the interval Ib_j. FIG. 22A shows an example of the frequency distribution of the concentration ratio B calculated in S1320.

After execution of the processing of S1320, the frequency distribution of the concentration ratio B is corrected to show unimodality (S1330).

Specifically, the interval Ib_j having the highest frequency Hb[j] is identified. Then, the interval Ib_j having the highest frequency Hb[j] is defined as a boundary. Subsequently, the frequency distribution is corrected so that the frequency Hb[j] of each interval Ib_j, which has the larger concentration ratio B than the boundary interval, is monotonically non-increasing. FIG. 22B is a graph describing the correction method of a frequency distribution.

Particularly, the frequency Hb[j] of each interval Ib_j is referred to successively starting from the boundary in the direction in which the concentration ratio B increases. Then, if a local peak (a local maximum point) of the frequency Hb[j] is detected, as shown in FIG. 22B, the frequency Hb[j] of each interval having the frequency lower than the local peak in the interval prior to the local peak is corrected to the frequency Hb[j] of the local peak.

Also, the frequency is corrected so that the frequency Hb[j] of each interval Ib_j having the concentration ratio B smaller than in the boundary interval is monotonically non-decreasing. Specifically, the frequency Hb[j] of each interval Ib_j is successively referred to starting from the boundary in the direction in which the concentration ratio B decreases. Then, if a local peak (a maximum point) of the frequency Hb[j] is detected, the frequency Hb[j] of each interval having the frequency Hb[j] lower than the local peak in the interval prior to the local peak (that is, the interval having the concentration ratio B larger than that corresponding to the local peak, on the premise that the concentration ratio B is smaller than the starting point) is corrected to the frequency Hb[j] of the local peak.

As described above, in S1330, a correction is made so that a local peak does not exist and the frequency distribution of the concentration ratio B includes a single peak. Hereinafter, the frequency after correction is expressed as Hb′[j].

Also, when the above processing is completed, the operation device 10 transforms the frequency distribution after correction into a probability distribution of the concentration ratio B (S1340). FIG. 22C is a graph showing the probability distribution of the concentration ratio B after correction. Specifically, an occurrence probability Pb[j] of the concentration ratio B corresponding to each interval Ib_j (j=0, 1, 2, . . . , Nb−1) is calculated by the following formula, wherein Σ represents a total amount of the frequencies Hb′[j] after correction of all intervals:

Pb[j]=Hb′[j]/Σ

After the probability distribution of the concentration ratio B obtained by making a correction to show unimodality as described above, the momentary number of transactions Qs[m, n, j] is calculated for each combination of the basic number of transactions R, the market price fluctuation amount G and the concentration ratio B (S1350).

Specifically, the momentary number of transactions Qs[m, n, j] for each combination of the number of transactions Es[m, n] per day and the concentration ratio B of each interval Ib_j is calculated by the following formula (m=0, 1, . . . , Nr−1, n=0, 1, . . . , Ng−1, j=0, 1, . . . , Nb−1), using the number of transactions Es[m, n] per day calculated in S1300 and a representative value St(Ib_j) of the concentration ratio B for each interval Ib_j.

Qs[m,n,j]=Es[m,n]·St(Ib_{—}j)

wherein the representative value St(Ib_j) can be defined to be a median value (B0+(j+½)·(B1−B0)/Nb) in the interval Ib_j.

Furthermore, the operation device 10 calculates a probability distribution of the momentary number of transactions Qs[m, n, j]. Specifically, an occurrence probability Pq[m, n, j] corresponding to the momentary number of transactions Qs[m, n, j] for each combination (m, n, j) of m=0, 1, . . . , Nr−1, n=0, 1, . . . , Ng−1 and j=0, 1, . . . , Nb−1 is calculated by the following formula (S1360):

Pq[m,n,j]=Pe[m,n]·Pb[j]

Then, a table (a distribution table) which stores the momentary number of transactions Qs[m, n, j] and the occurrence probability Pq[m, n, j] for each combination (m, n, j) as calculated above is generated, and the generated table is stored in the memory device 20. At this time, a record, which describes the momentary number of transactions Qs[m, n, j] and the occurrence probability Pq[m, n, j] corresponding to each combination (m, n, j), is sorted in ascending order of the momentary number of transactions Qs[m, n, j], and the sorted record is recorded in the distribution table (S1370).

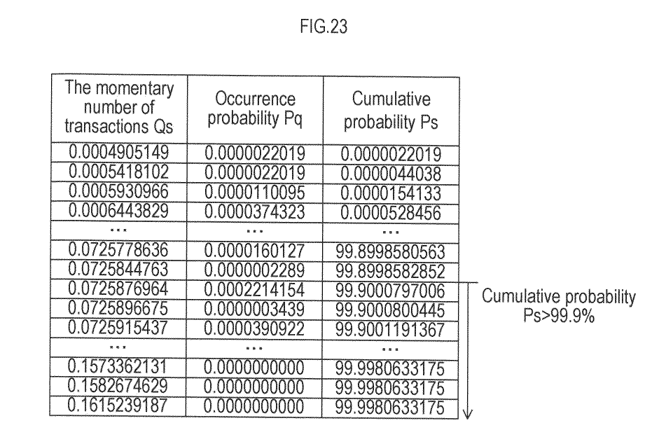

Furthermore, a cumulative probability Ps[m, n, j], which is obtained by adding together the occurrence probability Pq[m, n, j] of each record representing the momentary number of transactions Qs[m, n, j] equal to or smaller than the record to be recorded, is recorded in each record (S1380). The cumulative probability Ps[m, n, j] indicates the probability with which the largest momentary number of transactions (per user) for each day in the future is the momentary number of transactions Qs[m, n, j] or less. FIG. 23 shows an example of the structure of the distribution table in the present embodiment.

Thereafter, the operation device 10 identifies a minimum value of the momentary number of transactions Qs in a range where the cumulative probability is greater than a specific probability (99.9% in the present embodiment). In the present embodiment, the identified value is predicted to be the upper limit Qz of the momentary number of transactions Qs in the future (S1390). That is, when a record is referred to in ascending order of the momentary number of transactions Qs, the momentary number of transactions Qs right after the cumulative probability exceeds the specific probability is predicted as the upper limit Qz.

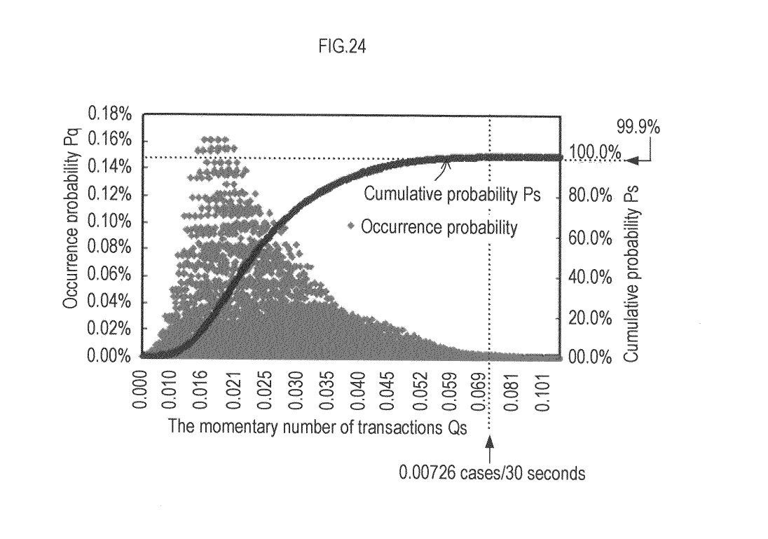

Also, when the above processing is completed, the operation device 10 displays a graph (see FIG. 24), which plots the cumulative probability Ps for each momentary number of transactions Qs on the display device 30. In the graph, the horizontal axis represents the momentary number of transactions Qs, and the vertical axis represents the cumulative probability Ps. In the graph, the predicted upper limit Qz of the momentary number of transactions Qs is displayed too (S1395). FIG. 24 shows structure of the graph displayed in S1395. In the example shown in FIG. 24, the occurrence probability Pq[m, n, j] corresponding to the momentary number of transactions Qs[m, n, j] for each combination (m, n, j) is further plotted in the graph. In this manner, according to the present embodiment, the predicted results with respect to an upper limit Qz of the momentary number of transactions Qs is informed to an operator of the prediction apparatus 1 through the display device 30.

Thereafter, the operation device 10 executes the processing of S1400 and S1410 to calculate the operation capacity necessary for the transaction system MS based on the upper limit Qz predicted in S1390. Then, the calculated result is informed to the operator of the prediction apparatus 1. Specifically, in S1400, an input of the number of transactions Ap which can be simultaneously processed by each CPU mounted in the transaction system MS and the assumed number of users U0 of the transaction system MS is accepted. Then, in S1410, based on the information regarding the number of transactions Ap and the assumed number of users U0 inputted through the input device 40, a predicted value Z of the number of necessary CPUs is calculated as the operation capacity necessary for the transaction system MS, by the following formula. Then, the calculated value Z is displayed on the display device 30.

Z=Qz·U0/Ap

The upper limit Qz of the momentary number of transactions Qs predicted in S1390 is the value per user. Therefore, here, the number of necessary CPUs Z is calculated by multiplying the upper limit Qz by the assumed number of users U0, and dividing the multiplied value Qz·U0 by the number of transactions Ap which can be simultaneously processed per CPU.

Furthermore, the operation device 10 executes the processing of S1420 and S1430 to calculate an estimated value Um of the limit number of users, which is an upper limit of the number of users which can be accepted in the present transaction system MS. Specifically, in S1420, an input of the originally assumed limit number of users Um0 and the originally assumed upper limit Qz0 of the momentary number of transactions is accepted. Then, in S1430, based on the information regarding the limit number of users Um0 and the upper limit Qz0 inputted through the input device 40, and the upper limit Qz predicted in S1390, a latest estimated value Um of the limit number of users is calculated by the following formula, and the calculated value Um is displayed on the display device 30:

Um=Um0·Qz0/Qz

As described above, according to the prediction processing, the information regarding the predicted value Z of the number of necessary CPUs in the future and the estimated value Um of the limit number of users in the current situation is provided to an operator of the prediction apparatus 1 through the display device 30.

According to the prediction apparatus 1 of the present embodiment described above, the probability distribution of the number of transactions Es per day is calculated (S1310), and the probability distribution of the concentration ratio B is calculated (S1340). Then, based on these probability distributions, the prediction apparatus 1 adequately predicts the upper limit Qz of the momentary number of transactions Qs to be realistically considered, in which the momentary number of transactions whose occurrence possibility is fully low is omitted. Therefore, by modifying the transaction system MS or configuring a new transaction system MS based on the upper limit Qz predicted by the prediction apparatus 1, the processing capability of the system can be set as necessary and sufficient for a stable operation, thereby realizing an efficient operation of the system while inhibiting an excess investment in the system.

Especially, according to the present embodiment, the probability distribution of the basic number of transactions R is calculated by removing the fluctuation amount V caused by market price fluctuations from the actual value of the number of transactions E (S1280 to S1287), and the probability distribution of the market price fluctuation amount G is calculated (S1290 to S1297). Based on these probability distributions, the probability distribution of the number of transactions per day Es=R+K·G is calculated (S1310). In the formula, K represents the basic fluctuation amounts KH and KL. Then, based on the calculated probability distribution and the probability distribution of the concentration ratio B, the probability distribution (cumulative probability distribution) of the momentary number of transactions Qs=Es·B is calculated (S1360 to S1380) to predict the upper limit Qz (S1390).

Therefore, according to the present embodiment, it is possible to accurately predict the upper limit Qz of the momentary number of transactions Qs, in consideration of a fluctuation amount V of the number of transactions E caused by market price fluctuations.

In addition, in the present embodiment, the prediction apparatus 1 is configured to predict the upper limit Qz of the momentary number of transactions per user. Thus, necessary operation capacity (the number of necessary CPUs Z) is calculated by taking the future prospected number of users U0 into account. Therefore, according to the prediction apparatus 1 of the present embodiment, it is possible to adequately make an investment in the system when the number of users U is estimated to increase in the future, thereby realizing an efficient operation of the system.

The correspondence relation between the terms regarding the prediction apparatus 1 according to the third embodiment is as follows. The function of generating the transaction performance data through the processing of S1110 to S1190 and reading the generated data corresponds to an example of the function realized by the acquisition device (procedure). The function realized by the processing of S1310 corresponds to an example of the function realized by the jobs distribution calculation device (procedure). In addition, the function realized by the processing of S1320 to S1340 corresponds to an example of the function realized by the concentration ratio distribution calculation device (procedure), and the function realized by the processing of S1350 to S1390 corresponds to an example of the function realized by the prediction device (procedure).

Also, the function realized by the processing of S1210 and S1220 corresponds to an example of the function realized by the basic fluctuation amount calculation device (procedure), and the function realized by the processing of S1230 to S1270 corresponds to an example of the function realized by the basic transactions calculation device (procedure). The function realized by the processing of S1280 to S1287 corresponds to an example of the function realized by the transactions distribution calculation device (procedure), and the function realized by the processing of S1290 to S1297 corresponds to an example of the function realized by the fluctuation amount distribution calculation device (procedure). The function realized by the processing of S1410 corresponds to an example of the function realized by the operation units calculation device (procedure).

### Fourth Embodiment

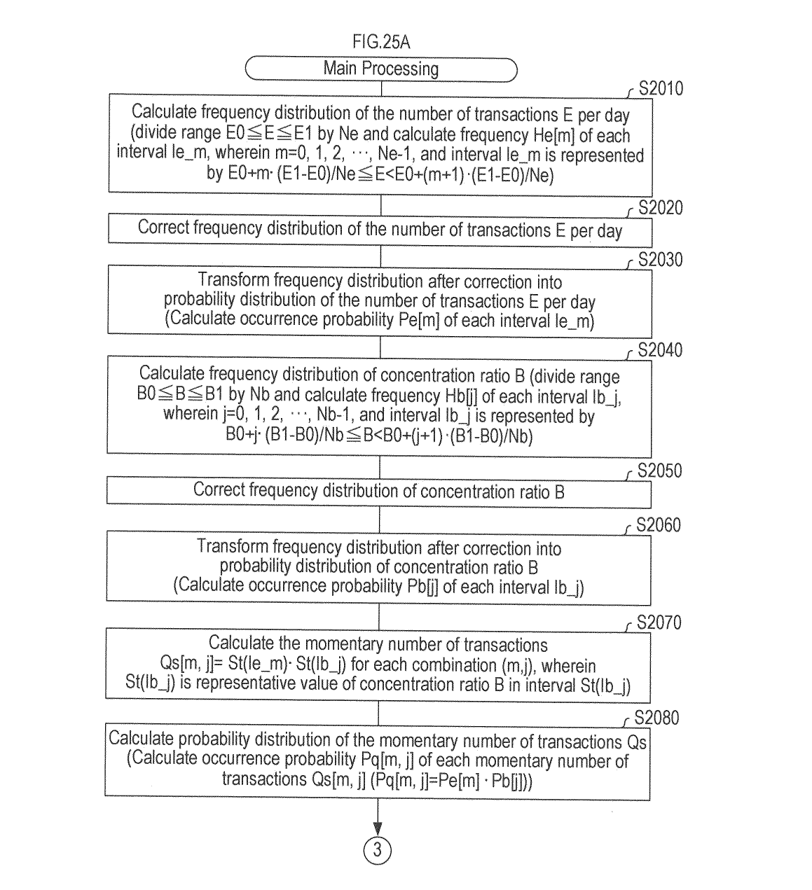

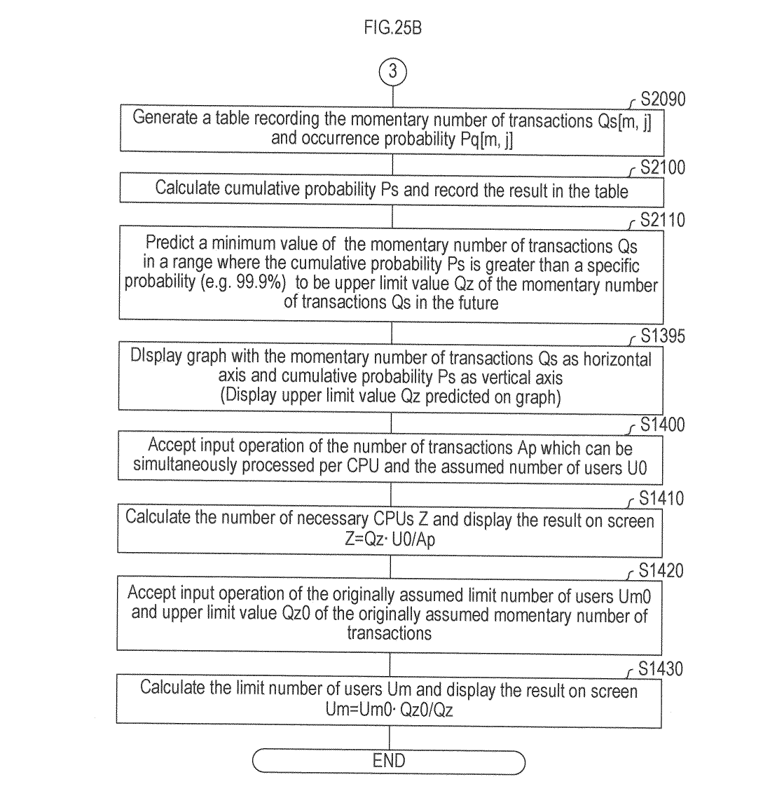

Although in the third embodiment, an example in which the present invention is applied to a foreign exchange transaction has been described above, the present invention can be used for predicting an upper limit of the momentary number of transactions for other various types of transaction. When the idea according to the third embodiment is used to a transaction involving no market prices, the main processing (see FIG. 19A and FIG. 19B) executed by the prediction apparatus 1 may be simply changed as shown in FIG. 25A and FIG. 25B.

According to a prediction apparatus 1 according to the fourth embodiment which predicts an upper limit of the momentary number of transactions for a transaction involving no market prices, the operation device 10 executes the processing of S110 to S180 in accordance with the prediction processing shown in FIG. 17 in the same manner as the third embodiment. Then, the operation device 10 skips S190 to proceed to S200. In S200, the main processing shown in FIG. 25A and FIG. 25B is executed.

In the main processing, the processing of S2010 to S2030 is firstly executed. In S2010, a frequency distribution of the number of transactions E per day per user in the sample period is calculated based on the same idea as the processing of S1280 in the third embodiment. That is, a range E0≦E≦E1 of the number of transactions E per day per user, for which the frequency distribution is calculated, is divided by a predetermined division number Ne, and a frequency He[m] of the number of transactions E per day per user corresponding to each divided interval Ie_m (wherein, m=0, 1, 2, . . . , Ne−1) is calculated. The frequency He[m] is the number of samples for the number of transactions E per day per user included in the interval Ie_m, and corresponds to the number of occurrence days on which the number of transactions E per day per user is included in the interval Ie_m.

E0 can be set as a minimum value of the number of transactions E per day per user in the sample period, and E1 can be set as a maximum value of the number of transactions E per day per user in the sample period.

As another example, when a probability distribution of the number of transactions E per day per user is presumed to a normal distribution, a mean σe and a standard deviation σe of the number of transactions E per day per user may be calculated, based on a group of the numbers of transactions per day E in the sample period, and the range E0≦E≦E1 of the number of transactions E may be defined to be the range μe−5σe≦E≦μe+5σe (E0=μe−5σe, E1=μe+5σe) in which an occurrence probability is generally 100%. However, since the number of transactions E per day per user cannot be a negative value, E0=0 is defined in the case of μe−5σe<0.

After the processing of S2010, the operation device 10 corrects the frequency distribution of the number of transactions E per day per user calculated in S2010 so as to show unimodality (S2020). That is, based on the same idea as the above embodiment, the interval Ie_m having the highest frequency He[m] is identified. Then, the interval Ie_m having the highest frequency He[m] is defined as a boundary. Subsequently, a correction is made so that the frequency He[m] of each interval Ie_m, which has the larger number of transactions E per day per user than the boundary interval, is monotonically non-increasing, and the frequency He[m] of each interval Ie_m, which has the smaller number of transactions E per day per user than the boundary interval, is monotonically non-decreasing. Hereinafter, with respect to the frequency Hr[m] of the number of transactions E per day per user, the frequency after correction is expressed as Hr′[m].

When the above processing is completed, the operation device 10 transforms the frequency distribution after correction into a probability distribution of the number of transactions E per day per user (S2030). Specifically, an occurrence probability Pe[m] of the number of transactions E per day per user corresponding to each interval Ie_m (m=0, 1, 2, . . . , Ne−1) is calculated by the following formula:

Pe[m]=He′[m]/Σe

wherein Σe represents a total amount of the frequencies He′[m] after correction of all intervals.

After the probability distribution of the number of transactions E per day per user obtained by making a correction to show unimodality as described above is calculated, similarly to S1320 to S1340 (see FIG. 20) according to the third embodiment, a frequency distribution of the concentration ratio B is calculated (S2040). Then, the calculated frequency distribution is corrected to show unimodality (S2050). The frequency distribution after correction is transformed into a probability distribution (S2060). Thus, an occurrence probability Pb[j] of the concentration ratio B corresponding to each interval Ib_j (j=0, 1, 2, . . . , Nb−1) is calculated.

Thereafter, the processing proceeds to S2070. In S2070, the momentary number of transactions Qs[m, j] for each combination of the number of transactions E per day per user and the concentration ratio B is calculated by the following formula (m=0, 1, . . . , Ne−1, j=0, 1, . . . , Nb−1). In the formula, St(Ib_j) is, similarly to the third embodiment, a representative value of the concentration ratio B of the interval Ib_j, and St(Ie_m) is a representative value (for example, a median value) of the number of transactions E per day per user of the interval Ie_m:

Qs[m,j]=St(Ie_{—}m)·St(Ib_{—}j)

Also, in S2080, similarly to S1360 according to the third embodiment, a probability distribution of the momentary number of transactions Qs[m, j] is calculated. Specifically, an occurrence probability Pq[m, j] corresponding to the momentary number of transactions Qs[m, j] for each combination (m, j) of m=0, 1, . . . , Ne−1 and j=0, 1, . . . , Nb−1 is calculated by the following formula:

Pq[m,j]=Pe[m]·Pb[j]

Then, in S2090, similarly to S1370 according to the third embodiment, a table (a distribution table) which stores the momentary number of transactions Qs[m, j] and the occurrence probability Pq[m, j] for each combination (m, j) calculated in S2070 and S2080 is generated. Then, the generated table is recorded in the memory device 20. At this time, a record, which describes the momentary number of transactions Qs[m, j] and the occurrence probability Pq[m, j] corresponding to each combination (m, j), is sorted in ascending order of the momentary number of transactions Qs[m, j]. Then, the sorted record is recorded in the distribution table.

Furthermore, in S2100, similarly to S1380 according to the third embodiment, a cumulative probability Ps[m, j], which is obtained by adding together the occurrence probability Pq[m, j] of each record representing the momentary number of transactions Qs[m, j] equal to or smaller than the record to be recorded, is recorded in each record.

Thereafter, the operation device 10 identifies, similarly to S1390 according to the third embodiment, a minimum value of the momentary number of transactions Qs in a range where the cumulative probability is greater than a specific probability (99.9% in the present embodiment). In the present embodiment, the identified value is predicted as an upper limit Qz of the momentary number of transactions Qs in the future (S2110). Also, after execution of S2110, the processing similar to S1395 to S1430 of the third embodiment is executed.

By configuring the prediction apparatus 1 as described above, the prediction apparatus 1 can be used for predicting an upper limit of the momentary number of transactions Qs for the transaction involving no market prices.

### Fifth Embodiment

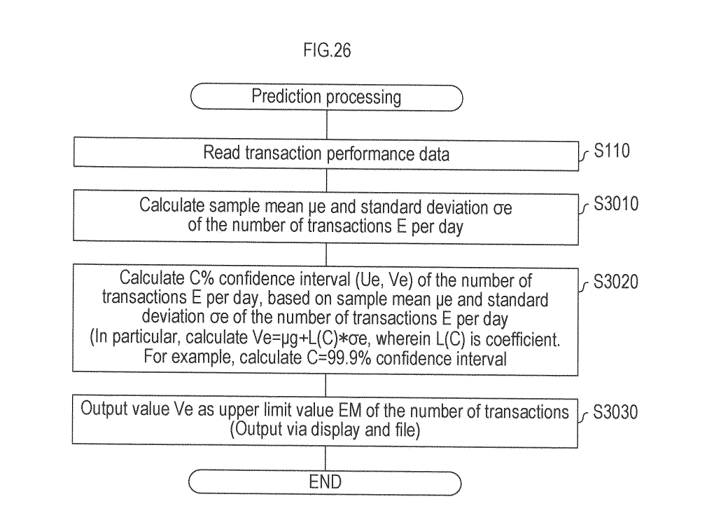

Although an example, in which the present invention is applied to the foreign exchange transaction, has been described in the first and second embodiments, these ideas can be also used for predicting an upper limit of the number of transactions per day for other various types of transaction. When the idea of the first embodiment is used for the transaction involving no market prices, the prediction processing (see FIG. 3A and FIG. 3B) executed by the prediction apparatus 1 may be simply changed as shown in FIG. 26.

According to the prediction apparatus 1 of the fifth embodiment, which predicts an upper limit of the number of transactions per day for the transaction involving no market prices, the operation device 10, as shown in FIG. 26, does not execute the processing of S120 to S180, and executes the processing of S3010 to S3030, instead of execution of the processing of S190 to S260.

That is, once the prediction processing is started, similarly to the first embodiment, the operation device 10 reads a transaction performance data stored in the memory device 20 through the external I/O device 50 (S110). In the transaction performance data, a record, which includes a date T, the number of transactions A of the day, the number of users U which is the number of users allowed to use the transaction system MS, and the number of transactions E per user of the day, shall be recorded for each day in a predetermined period (for example, one year) in the past.

When the transaction performance data configured as described above is read in S110, the operation device 10 proceeds to S3010. In S3010, by using, as a sample group, a group of records included in the transaction performance data, a mean μe and a standard deviation σe of the number of transactions E per day per user is calculated.

Then, based on the mean μe and standard deviation σe calculated above, a confidence interval (Ue, Ve) at a C % confidence level of the number of transactions E per day per user is calculated. That is, the values Ue and Ve each corresponding to a confidence interval endpoint is calculated (S3020). Similarly to the first embodiment, here, it is considered that the target, for which the confidence interval is calculated, follows a normal distribution. Accordingly, by setting the confidence level C as 99.9%, the values Ue and Ve corresponding to each endpoint of the 99.9% confidence interval (Ue, Ve) for the number of transactions E per day per user can be calculated.

The values Ue and Ve corresponding to each endpoint of the confidence interval (Ue, Ve) at a C % confidence level of the number of transactions E per day per user can be calculated by the following formula:

Ue=μe−L(C)·σe

Ve=μe+L(C)·σe

wherein L(C) is a coefficient defined by a confidence level. Similarly to the first embodiment, L(C)=3.3 can be used. Also, since only the value Ve of the values Ue and Ve is required here, it is enough to calculate only the value Ve of the upper endpoint of the confidence interval (Ue, Ve).

In this connection, the value Ve to be calculated in S3020 corresponds to an upper limit EM of the predicted number of transactions per day per user. Therefore, in S3030, the calculated value Ve is displayed on the display device 30, as an upper limit EM of the number of transactions per day per user that is predicted in the future in the transaction system. At the same time, a log file which describes the upper limit EM of the number of transactions is generated, and the generated log file is stored in the memory device 20.

By configuring the prediction apparatus 1 as described above, the prediction apparatus 1 can be used for predicting an upper limit of the number of transactions per day per user for the transaction involving no market prices.

### Sixth Embodiment

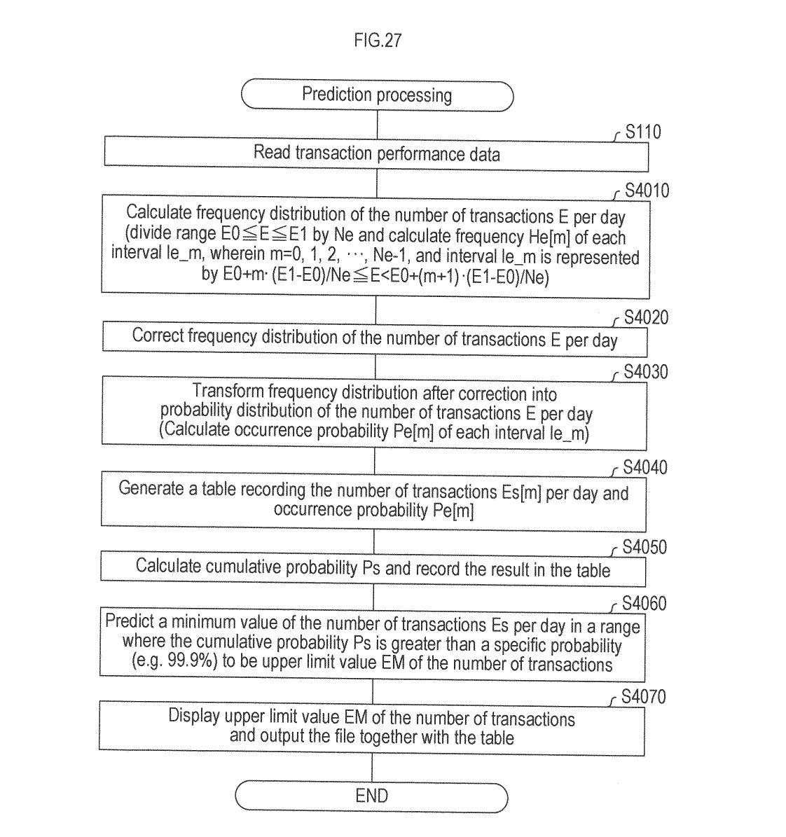

When the idea according to the second embodiment is used for the transaction involving no market prices, the prediction processing (see FIG. 9) executed by the prediction apparatus 1 may be simply modified as shown in FIG. 27.

According to a prediction apparatus 1 of the sixth embodiment for predicting an upper limit of the number of transactions per day for the transaction involving no market prices, the operation device 10, as shown in FIG. 27, does not execute the processing of S120 to S180, but executes the processing of S4010 to S4070, instead of the processing of S310 to S420.

That is, once the prediction processing is started, the operation device 10 reads, similarly to the first embodiment, a transaction performance data stored in the memory device 20 through the external I/O device 50 (S110). Thereafter, the processing of S4010 to S4030 is executed.

In S4010 to S4030, the operation device 10 calculates, similarly to the processing of S2010 to S2030, a frequency distribution of the number of transactions E per day per user in the sample period, based on a group of records recorded in the transaction performance data (S4010). Then, the calculated frequency distribution is corrected to show unimodality (S4020), and the corrected frequency distribution is transformed to a probability distribution (S4030). Thus, the probability distribution of the number of transactions E per day per user, which is corrected to show unimodality, is calculated.

That is, a range E0≦E≦E1 of the number of transactions E per day per user, for which a frequency distribution is calculated, is divided by a predetermined division number Ne, and a frequency He[m] of the number of transactions E per day per user corresponding to each divided interval Ie_m (wherein, m=0, 1, 2, . . . , Ne−1) is calculated.

Then, each calculated frequency is corrected, so that the frequency is monotonically non-increasing in an interval having the number of transactions E per day per user larger than that of the interval having the highest frequency, and so that the frequency is monotonically non-decreasing in the interval having the number of transactions E per day per user smaller than that having the highest frequency. Then, the frequency distribution after correction is transformed to a probability distribution. The probability distribution of the number of transactions E per day per user showing unimodality is calculated by the above transformation. Hereinafter, the occurrence probability of the number of transactions E per day per user for each interval Ie_m (m=0, 1, 2, . . . , Ne−1) is expressed as Pe[m], and a representative value St(Ie_m) of the number of transactions E per day per user in each interval Ie_m (m=0, 1, 2, . . . , Ne−1) is expressed as Es[m].

Thereafter, the operation device 10 proceeds to S4040. In S4040, a table (a distribution table), which stores the number of transactions Es[m] per day per user and the occurrence probability Pe[m] for each interval, is generated. Then, the generated table is stored in the memory device 20. At this time, a record, which describes, for each interval, the number of transactions Es[m] per day per user and the occurrence probability Pe[m], is sorted in ascending order of the number of transactions Es[m] per day per user. Then, the sorted record is recorded in the distribution table.

Furthermore, in S4050, a cumulative probability Ps[m], which is obtained by adding together the occurrence probability P[m] of the record representing the number of transactions Es[m] per day per user equal to or smaller than the record to be recorded, is recorded in each record.

Thereafter, the operation device 10 identifies a minimum value of the number of transactions Es[m] per day per user in a range where the cumulative probability is greater than a specific probability (99.9% in the present embodiment). In the present embodiment, the identified value is predicted to be an upper limit EM of the number of transactions per day per user in the future (S4060). Also, after execution of S4060, the predicted upper limit EM of the number of transactions is displayed on the display device 30. At the same time, a log file, which describes the upper limit EM of the number of transactions and the distribution table, is generated. Then, the generated log file is stored in the memory device 20 (S4070).

By configuring the prediction apparatus 1 as described above, the prediction apparatus 1 can be used for predicting an upper limit of the number of transactions per day per user for the transaction involving no market prices.

[Others]

Although the first to sixth embodiments have been described above, the present invention is not limited to the above embodiments but can be implemented in various aspects. For example, other than transactions, the present invention can be applied for various systems which execute jobs in response to requests from outside. The system as described herein may be a system in which a person, other than the information processing system, executes a work (job) in response to a request from a client. For example, in the call center (system) in which requests from clients is received through telephone lines and jobs responding to the requests is performed, the prediction apparatus according to the present invention can be used for adequately adjusting the amount of telephone lines and the number of persons to be prepared on the part of the call center.

In this connection, the prediction apparatus 1 according to the fourth to sixth embodiments can be also implemented for predicting an upper limit of the number of job executions per day or the number of job executions per very short time period (the momentary number of jobs) in the system executing various jobs which are not affected by market price fluctuation.

In addition, although an example of the transaction, in which the number of transactions increases in response to market price fluctuations, has been described in the first to third embodiments, the other type of transaction in which the number of transactions decreases in response to market price fluctuations may exist. Therefore, the above-mentioned prediction apparatus 1 may be configured as an apparatus for predicting an upper limit of the number of transactions per day or the momentary number of transactions for the transaction in which the number of transactions decreases in response to the market price fluctuations. When the prediction apparatus 1 according to the first embodiment is configured to be applicable for this type of transaction, an upper limit EM of the number of transactions can be calculated as the value Vr of the upper endpoint in the confidence interval (Ur, Vr) of the basic number of transactions R.

In addition, although the technology of generating a plurality of virtual machines in a single host computer has been known in recent years, when the above transaction system MS is realized in the virtual machines, resources can be dynamically allocated in accordance with the predicted result.

For example, although an example, in which the predicted result of the upper limit Qz is used for modifying or newly constructing a computer (a server) in use for the transaction system MS, has been described in the third embodiment, when the transaction system MS is virtually realized in the host computer, resources can be also adjusted depending on the momentary number of transactions, by adjusting the allocation rate of the CPU to the transaction system MS.

What is claimed is:

1. A prediction apparatus that predicts an upper limit of a number of job executions per unit period in a system executing a job responding to a request from outside, comprising:
an acquisition device that acquires a sample data regarding the job, from which a number of job executions for each unit period in a past can be identified; and
a prediction device that predicts the upper limit of the number of job executions per unit period in a future, based on a distribution of the number of job executions for each unit period identified from the sample data, and then outputs the predicted upper limit.

2. The prediction apparatus according to claim 1, wherein the prediction device:
calculates a value of an endpoint of a confidence interval at a predetermined confidence level of the number of job executions per unit period, based on the number of job executions for each unit period identified from the sample data, on an assumption that a probability distribution of the number of job executions per unit period follows a normal distribution; and
predicts the upper limit of the number of job executions per unit period based on the value of the endpoint of the confidence interval.

3. The prediction apparatus according to claim 2, wherein the prediction device predicts a value of an upper endpoint of the confidence interval to be the upper limit of the number of job executions per unit period.

4. The prediction apparatus according to claim 1, wherein the prediction device calculates a probability distribution of the number of job executions per unit period, based on the number of job executions for each unit period identified from the sample data, and predicts the upper limit of the number of job executions per unit period based on the calculated probability distribution.

5. The prediction apparatus according to claim 4, wherein
the prediction device predicts a minimum value of the number of job executions per unit period in a range where a cumulative probability is greater than a specific probability to be the upper limit of the number of job executions per unit period, the cumulative probability being a cumulative probability of the number of job executions per unit period and changing in accordance with the number of job executions per unit period, which functions as a variable, and
the cumulative probability is calculated by accumulating an occurrence probability for each value of the number of job executions per unit period identified from the probability distribution, in ascending order of the value of the number of job executions per unit period, up to a value of the number of job executions per unit period corresponding to the variable.

6. The prediction apparatus according to claim 4, wherein the prediction device calculates the probability distribution with an action of correction to show unimodality, and predicts the upper limit of the number of job executions per unit period based on the calculated probability distribution.

7. The prediction apparatus according to claim 1, wherein
the system is a system which executes as the job a transaction responding to a request from outside, and
the prediction device predicts, as the number of job executions per unit period, an upper limit of a number of transactions per unit period in the system.

8. A recording medium that is computer-readable and stores a program which causes a computer to execute processing of predicting an upper limit of a number of job executions per unit period in a system executing a job responding to a request from outside, the processing comprising:
a procedure that acquires a sample data regarding the job, from which a number of job executions for each unit period in a past can be identified; and
a procedure that predicts the upper limit of the number of job executions per unit period in a future, based on a distribution of the number of job executions for each unit period identified from the sample data, and outputting the predicted upper limit.

9. A prediction method that predicts an upper limit of a number of job executions per unit period in a system executing a job responding to a request from outside, comprising:
an acquisition procedure that acquires a sample data regarding the job, from which a number of job executions for each unit period in a past can be identified; and
a prediction procedure that predicts the upper limit of the number of job executions per unit period in a future, based on a distribution of the number of job executions for each unit period identified from the sample data, and then outputting the predicted upper limit.

10. The prediction method according to claim 9, wherein the prediction procedure is a procedure that
calculates a value of an endpoint of a confidence interval at a predetermined confidence level of the number of job executions per unit period, based on the number of job executions for each unit period identified from the sample data, on an assumption that a probability distribution of the number of job executions per unit period follows a normal distribution, and
predicts the upper limit of the number of job executions per unit period based on the value of the endpoint of the confidence interval.

11. The prediction method according to claim 10, wherein the prediction procedure is a procedure that predicts a value of an upper endpoint of the confidence interval to be the upper limit of the number of job executions per unit period.

12. The prediction method according to claim 9, wherein the prediction procedure is a procedure that
calculates a probability distribution of the number of job executions per unit period, based on the number of job executions for each unit period identified from the sample data, and
predicts the upper limit of the number of job executions per unit period, based on the calculated probability distribution.

13. The prediction method according to claim 12, wherein
the prediction procedure is a procedure that predicts a minimum value of the number of job executions per unit period in a range where a cumulative probability is greater than a specific probability to be the upper limit of the number of job executions per unit period, the cumulative probability being a cumulative probability of the number of job executions per unit period and changing in accordance with the number of job executions per unit period, which functions as a variable, and
the cumulative probability is calculated by accumulating an occurrence probability for each value of the number of job executions per unit period identified from the probability distribution, in ascending order of the value of the number of job executions per unit period, up to a value of the number of job executions per unit period corresponding to the variable.

14. The prediction method according to claim 12, wherein the prediction procedure is a procedure that calculates the probability distribution with an action of correction to show unimodality, and predicts the upper limit of the number of job executions per unit period based on the calculated probability distribution.

15. The prediction method according to claim 9, wherein
the system is a system which executes a transaction responding to a request from outside, and
the prediction procedure is a procedure that predicts an upper limit of a number of transactions per unit period in the system, as the number of job executions per unit period.
